(19) United States
(12) Patent Application Publication
(10) Pub. No.: US 2023/0145996 A1
(43) Pub. Date: May 11, 2023

(54) METHODS AND DEVICES FOR LIFTING BUILDING CONSTRUCTION CRANES

(71) Applicant: EllisDon Corporation, Mississauga (CA)

(72) Inventors: Stephen Lamont King, Burlington (CA); Philip Allan Jones, Waterdown (CA)

(73) Assignee: EllisDon Corporation, Mississauga (CA)

(21) Appl. No.: 17/522,686

(22) Filed: Nov. 9, 2021

(51) Int. Cl. B66C 23/32

(52) U.S. Cl. CPC B66C 23/32

(57) ABSTRACT

A device includes a climbing frame configured for connection to a support. The device also includes a hydraulic piston connected, at least indirectly, to the climbing frame. The hydraulic piston is oriented to urge, under a tension load, a mast of a crane upwardly against a force of gravity.

### BACKGROUND

A crane used in large-scale construction project may be referred-to as a “building construction crane,” a “building crane,” a “tower crane”, a “construction crane,” or simply a “crane.” As used herein, the term “crane” refers to such a crane used in construction. During construction of some multi-story buildings (e.g., a skyscraper), a crane may be lifted multiple times in order to reach higher as the building increases in height. Lifting the crane may be difficult and time-intensive, and thus expensive.

### SUMMARY

The one or more embodiments provide for a device. The device includes a climbing frame configured for connection to a support. The device also includes a hydraulic piston connected, at least indirectly, to the climbing frame. The hydraulic piston is oriented to urge, under a tension load, a mast of a crane upwardly against a force of gravity.

The one or more embodiments also provide for another device. The device includes a support including a first portion of a mast of a crane. The first portion of the mast of the crane is anchored to an anchor point. A second portion of the mast of the crane is unanchored to the first portion. The device also includes a climbing frame connected to the second portion of the mast and slidable along the first portion of the mast. The device also includes a hydraulic piston connected to the first portion of the mast and to the climbing frame. The hydraulic piston is oriented to pull the climbing frame under a tension load and further oriented to lift the second portion of the mast as the climbing frame is pulled by the hydraulic piston.

The one or more embodiments also provide for a system. The system also includes a lower grillage configured to slide along internal walls, beams, columns, or floors of a building. The system also includes a mast of a crane connected to the lower grillage. The system also includes a climbing frame configured for connection to the internal walls, beams, columns, or floors of the building. The climbing frame is disposed above the lower grillage relative to a direction of gravity. The system also includes a hydraulic piston connecting the lower grillage and the climbing frame. The hydraulic piston is oriented to urge the lower grillage towards the climbing frame under a tension load. The system also includes an upper grillage configured to slide along the internal walls, beams, columns, or floors of the building. The upper grillage is connected to the mast of the crane above the climbing frame relative to the gravity.

The one or more embodiments also provide for a method of lifting a crane. The method includes anchoring a climbing frame to a support. The climbing frame is connected to a hydraulic piston that is also connected to a lower grillage disposed under the climbing frame relative to a direction of gravity. The lower grillage is also connected to a mast of the crane. The method also includes pulling, using the hydraulic piston under a tension load, the lower grillage towards the climbing frame.

Other aspects of the one or more embodiments will be apparent from the following description and the appended claims.

### BRIEF DESCRIPTION OF DRAWINGS

FIG. 1 shows an example of a crane, in accordance with one or more embodiments.

FIG. 2A, FIG. 2B, FIG. 2C, FIG. 2D, FIG. 2E, FIG. 2F, and FIG. 2G show different aspects of a device for lifting a crane, in accordance with one or more embodiments.

FIG. 3A, FIG. 3B, and FIG. 3C pictorially illustrate a method for lifting a crane, in accordance with one or more embodiments.

FIG. 4A, FIG. 4B, FIG. 4C, FIG. 4D, FIG. 4E, FIG. 4F, and FIG. 4G show different aspects of another device for lifting a crane, in accordance with one or more embodiments.

FIG. 5A, FIG. 5B, FIG. 5C, FIG. 5D, and FIG. 5E show different aspects of another device for lifting a crane, in accordance with one or more embodiments.

FIG. 6A, FIG. 6B, and FIG. 6C pictorially show another method for lifting a crane, in accordance with one or more embodiments.

FIG. 7A, FIG. 7B, FIG. 7C, FIG. 7D, FIG. 7E, FIG. 7F, FIG. 7G, FIG. 7H, FIG. 7I, FIG. 7J, FIG. 7K, and FIG. 7L pictorially show another method for lifting a crane, in accordance with one or more embodiments.

FIG. 8 shows a flowchart of a method for lifting a crane, in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description.

In general, the one or more embodiments relate to devices and methods for lifting a crane. Lifting a crane presents multiple technical challenges. For example, when a crane is lifted using multiple hydraulic presses, the extreme weight of the crane can buckle the piston support rods that press against the crane. To prevent buckling in the piston support rods, the crane is pushed upwardly in incremental short strokes of the hydraulic presses. However, each time the crane is lifted, the crane is secured and checked. Thus, the process of lifting a crane to a desired height may take a day, multiple days, or longer.

The one or more embodiments address this and other technical challenges by providing a framework and orientation of components that place the hydraulic presses under a tension load, rather than under a compression load. For example, the hydraulic pistons may be flipped so that the pistons pull the weight of the crane, rather than push the weight of the crane. Adjustments are made to the frame(s) that are used to support the crane during the lifting process in order to allow the crane to be pulled upwardly under a tension load. Multiple embodiments are presented to show multiple different techniques for placing the hydraulic pistons under a tension load so that the crane is pulled upwardly, rather than pushed upwardly.

Placing the hydraulic pistons under a tension load reduces or eliminates buckling of the piston rods under the weight of the crane. As a result, the crane may be lifted in fewer, longer strokes of one or more hydraulic pistons. Accordingly, the one or more embodiments save both time and money during construction.

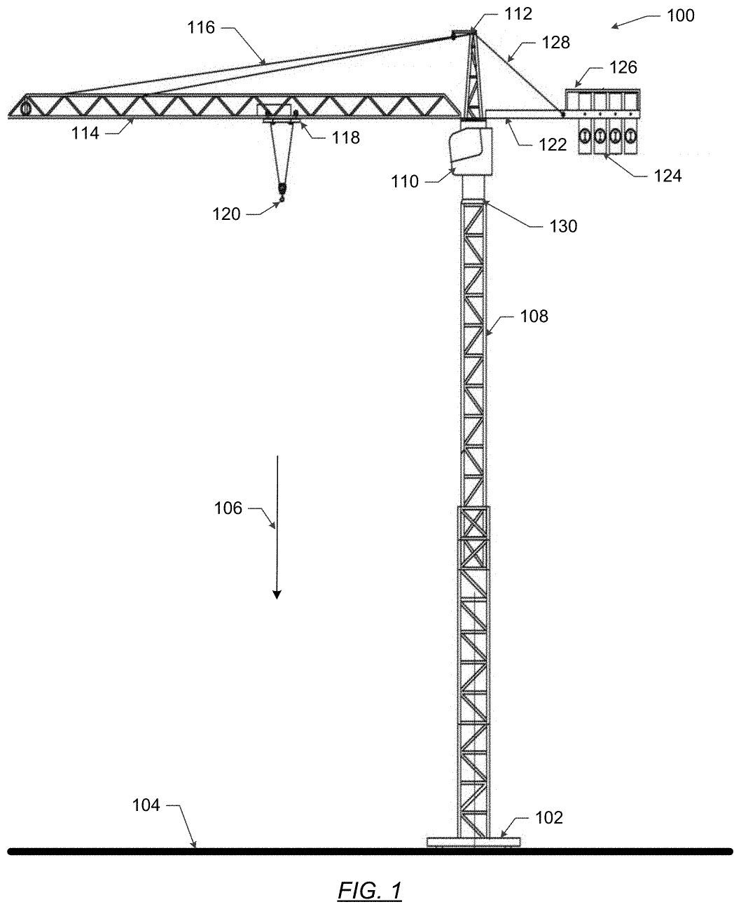

FIG. 1 shows an example of a crane, in accordance with one or more embodiments. The crane (100) rests on a base (102) that is anchored to a support (104). In FIG. 1, the support (104) is the ground, with the direction of gravity (106) shown for reference. However, as shown elsewhere herein, the support (104) may be a portion of a building, a manufactured frame, or some other anchoring system.

A mast (108) rests on and extends upwardly from the base (102). The mast (108) may include a ladder system that allows an operator to climb to a cab (110) that rests at location under an apex (112) of the mast (108). The cab (110) may contain controls, displays, computers, communication equipment, etc. useful for operating the crane (100) in use.

A jib (114) extends outwardly from the mast (108). The jib (114) supports the weight of objects lifted by the crane (100). The jib (114) may be provided with extra support from the mast (108) via a rear pendant (116) connected to the apex (112) of the mast (108) and to one or more distal portions of the jib (114). The term “distal” refers to points on the jib (114) further from the mast (108), and the term “proximal” refers to points on the jib (114) closer to the mast (108). In any case, the weights of the jib (114) and any objects suspended via the jib (114) are supported by the mast (108).

A counter jib (122) extends outwardly from the mast (108), opposed to the jib (114). A counterweight (124) is added to an end of the counter jib (122) in order to balance the weight of the jib (114) and objects supported by the jib (114). The counter jib (122) may receive additional support from a pendant (128) that connected between the apex (112) of the mast (108) and the counter jib (122).

The crane may lift objects using a hook block (120). The hook block (120) is connected to a trolley (118) which may move distally and proximally along the jib (114). The trolley (118) is, in turn, driven by a motor and winch system (126), which may be disposed towards a distal end of the counter jib (122). Furthermore, the apex (112) and the cab (110) may sit on a turntable (130) which is configured to rotate the cab (110), the apex (112), the jib (114), and the counter jib (122) as a unit. The turntable (130) may be considered part of the mast (108), as in some embodiments the upper and lower portions of the turntable (130) may form a defining line between the upper slewing works and the lower mast (108) connection.

In use, an operator in the cab (110) may use the trolley (118) to move the hook block (120) to a desired location distally or proximally along the jib (114). The jib (114) may be rotated on the turntable (130) in order to further position the hook block (120) over an object to be lifted (e.g., a girder to be placed on a building). The hook block (120) is lowered to the object, the object is secured to the hook block (120), and then the motor and winch system (126) is used to pull the hook block (120) to a desired elevation along the mast (108). Optionally, the jib (114) may be rotated again on the turntable (130) to bring the object to a desired location.

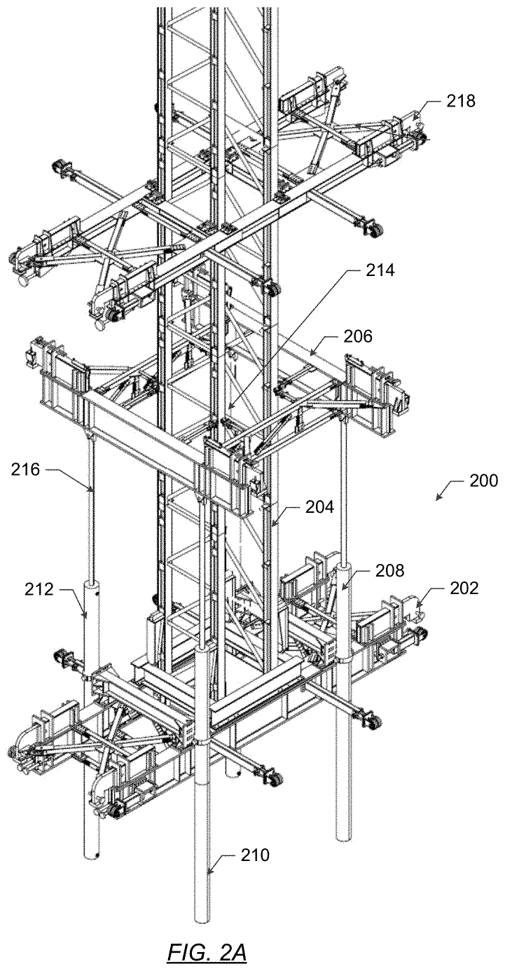

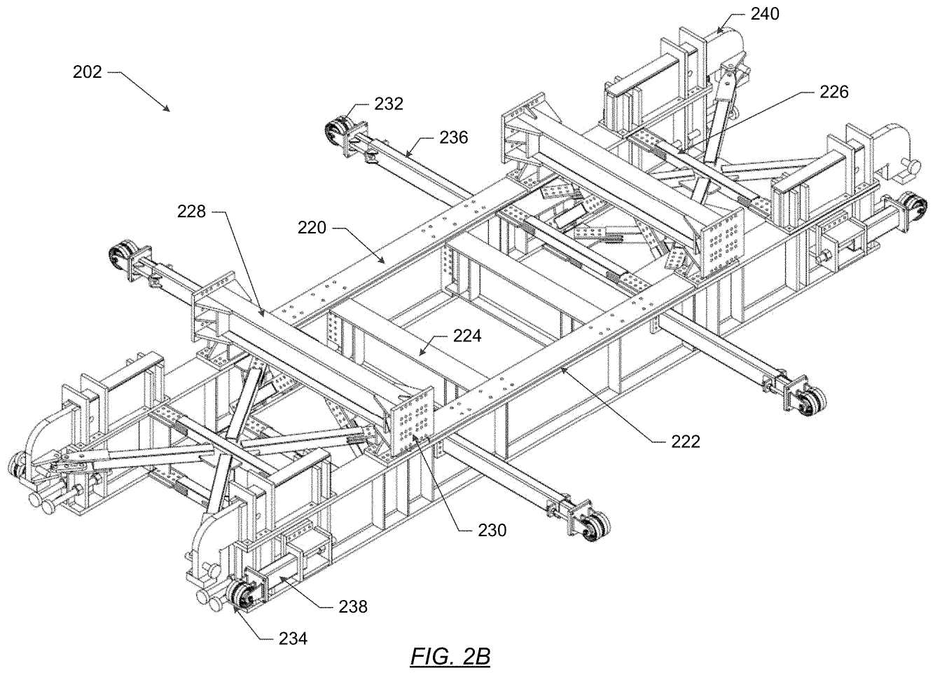

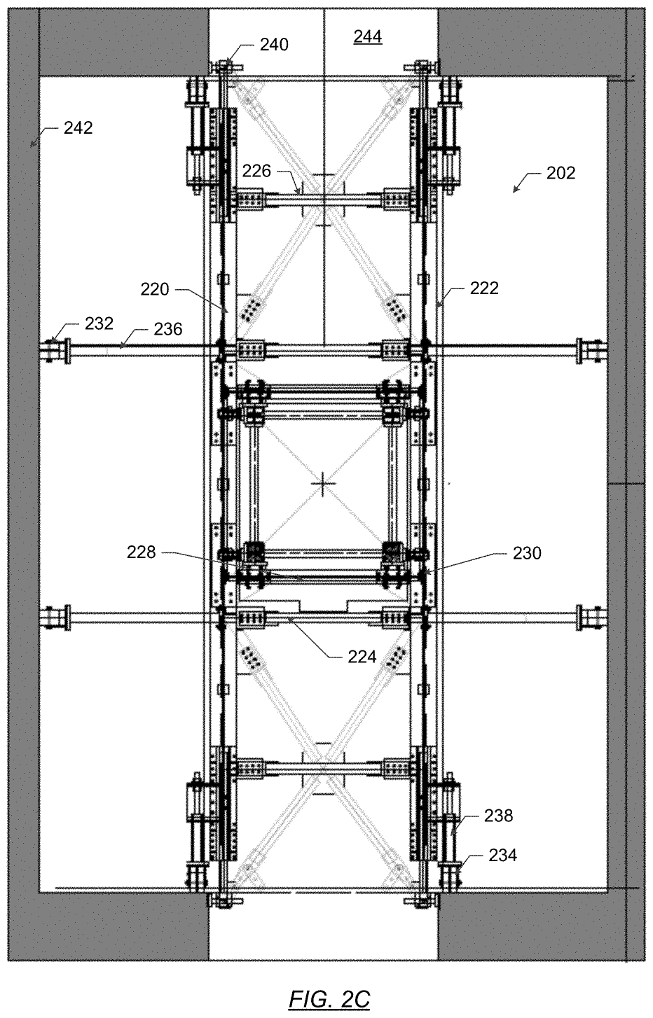

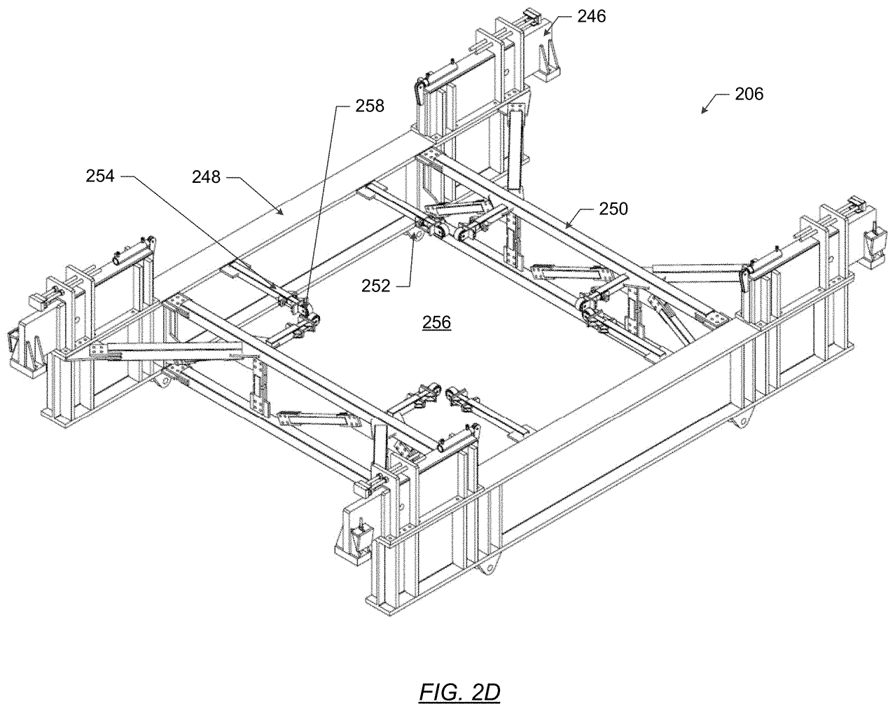

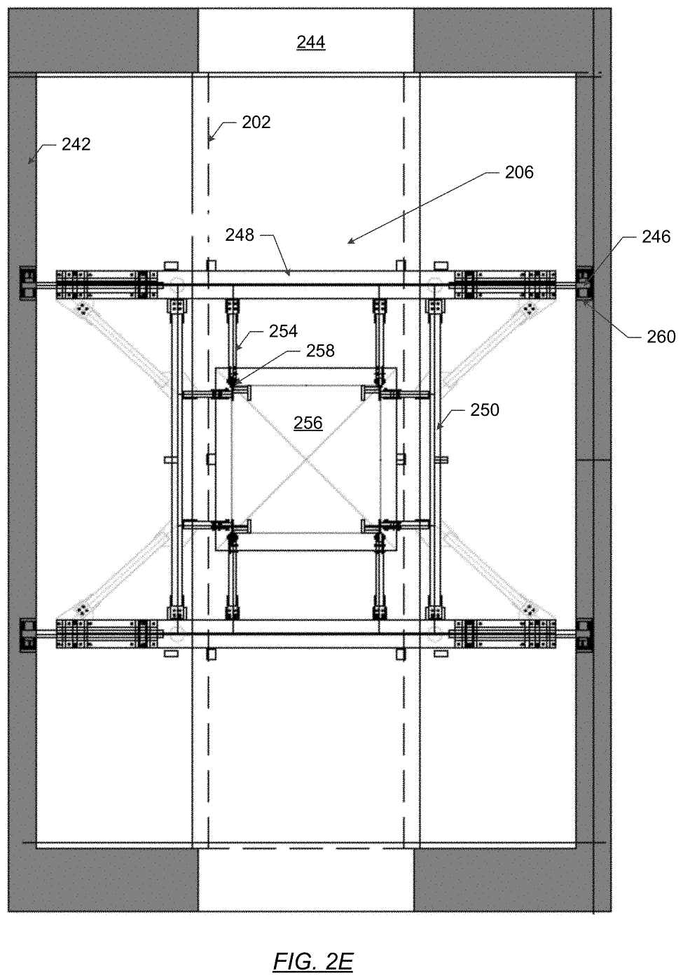

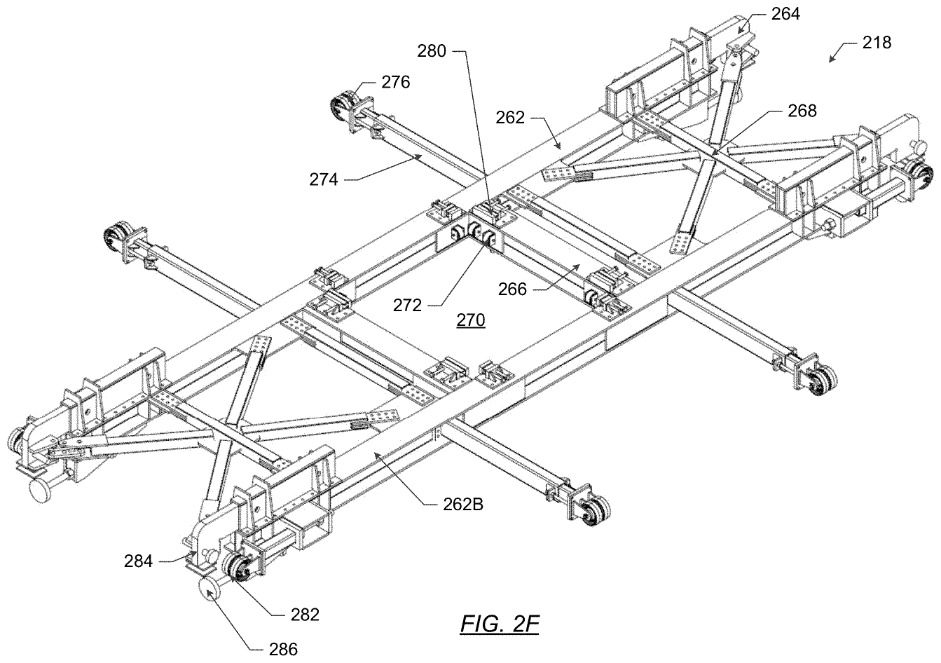

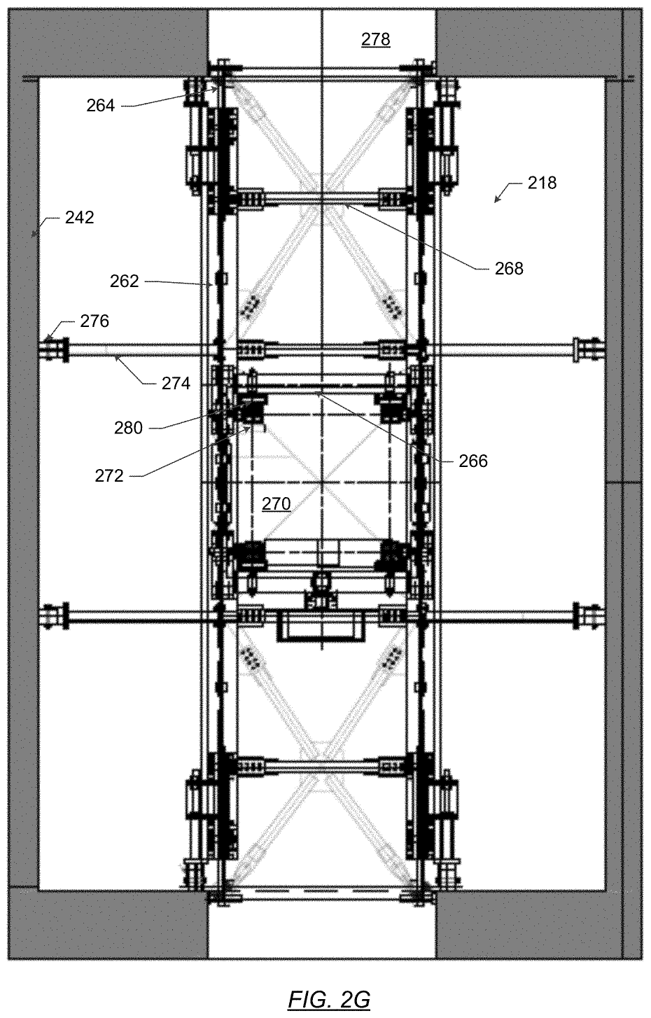

The crane of FIG. 1 is a tower crane used for illustration purposes. However, the one or more embodiments contemplate using the devices and methods of FIG. 2A through FIG. 8 to lift many different types of cranes, including hammerhead cranes, bridge cranes, jib cranes, stacker cranes, luffing jib cranes, level luffing cranes, and other types of cranes. Different types of cranes may have different arrangements of components, or may have additional components, or may not have certain components. For example, a luffing crane may not have the trolley (118), and instead may connect the hook block (120) to the tip of the jib (114). Many other arrangements are possible.

Attention is now turned to the use of the terms “upper” and “lower,” as used herein. The terms “upper” and “lower” refer to positions of similar parts of the device relative to each other along an axis defined by the direction of gravity (106). Thus, for example, an upper component is above a lower component along an axis defined along the direction of gravity (106). The term “above” is in a direction opposed to the force of gravity, and the term “below” is in a direction with the force of gravity, as is commonly understood. However, the terms “upper” and “lower” do not necessarily imply the location of a component with respect to a mast of a crane, or with respect to other components of a device. Thus, for example, a lower component need not be located at or near a bottom part of a crane mast. Similarly, for example, an upper component may be below some other aspect or part of a device, relative to the direction of gravity (106). Thus, the terms “upper” and “lower” may be considered nonce terms that only identify the relative locations of similar components with respect to each other. A specific example is the upper grillage and the lower grillage described with respect to FIG. 2A through FIG. 2G.

Attention is now turned to FIG. 2A through FIG. 2G, which show different aspects of a device for lifting a crane, in accordance with one or more embodiments. FIG. 2A shows an overview of the device used to lift a crane under a tension load. FIG. 2B through FIG. 2G show details of the components shown in FIG. 2A. FIG. 2A through FIG. 2G should be viewed together as a whole. Thus, common reference numerals used in FIG. 2A through FIG. 2G refer to common objects having common descriptions. The device shown in FIG. 2A through FIG. 2G is designed to lift a crane that is disposed inside a building under construction, such as when the crane is disposed in an elevator shaft of the building under construction.

The device (200) includes a lower grillage (202). The lower grillage (202) is attachable to a mast (204) of a crane. In FIG. 2A, the bottom of the mast (204) is attached to the lower grillage (202); however, in other embodiments, the lower grillage (202) may be attached to some other portion of the mast (204). Details of the lower grillage (202) are described with respect to FIG. 2B and FIG. 2C.

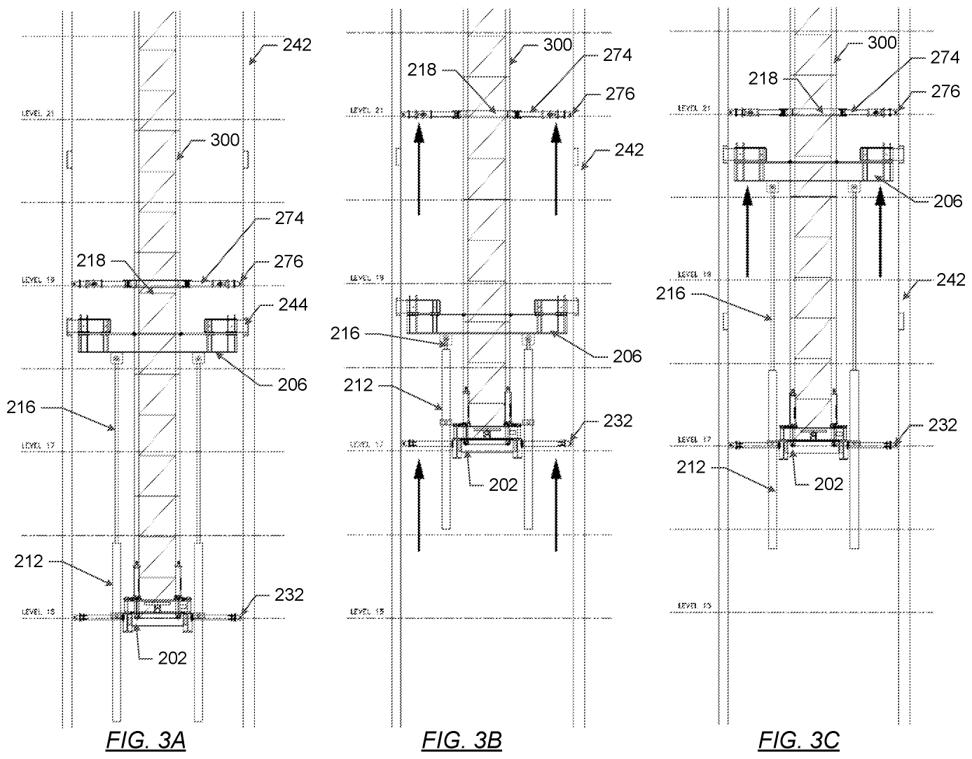

The device (200) also includes a climbing frame (206). The climbing frame (206) is attachable to inside walls of a building, or to some other support, as shown in FIG. 3A through FIG. 3C. In use, the mast (204) slides through the central portion of the climbing frame (206) while the mast (204) is being lifted. Details of the climbing frame (206) are described with respect to FIG. 2D and FIG. 2E.

The climbing frame (206) is connected to the lower grillage (202) via one or more hydraulic pistons. In the example of FIG. 2A, four hydraulic pistons are present, hydraulic piston (208), hydraulic piston (210), hydraulic piston (212), and hydraulic piston (214).

More or fewer hydraulic pistons may be present. In any case, a hydraulic piston is connected to both the lower grillage (202) and the climbing frame (206). For the sake of simplicity of explanation, reference is now made simply to “a hydraulic piston.” However, reference to “a hydraulic piston” automatically contemplates one or more hydraulic pistons.

The hydraulic piston is placed under a tension load. Thus, the hydraulic piston pulls the lower grillage (202) towards the climbing frame (206), thereby drawing the mast (204) upwardly. Because the hydraulic piston is under a tension load, buckling in the support rod of the hydraulic piston (e.g., support rod (216)) is reduced or eliminated. Accordingly, a single longer stroke of the hydraulic piston may be used to elevate the mast (204) higher than would have been possible had the support rod (216) pushed upwardly on the mast (204) while placing the support rod (216) under a compression load.

In some embodiments, the device (200) may be referred to as a system. The system may include other components that are not necessarily connected to each other, but which nevertheless act in concert to aid in lifting or securing the mast (204) during a lift operation. In the example of FIG. 2A, the system may include an upper grillage (218).

The upper grillage (218) slides along the walls of the building or some other support as the mast (204) is lifted. The upper grillage (218) aids in preventing the mast (204) from tipping from one side or another while the mast (204) is being lifted via the hydraulic piston pulling the lower grillage (202) towards the climbing frame (206). Details of the upper grillage (218) are described with respect to FIG. 2F and FIG. 2G. Use of the upper grillage (218) is shown with respect to FIG. 3A through FIG. 3C.

Attention is now turned to FIG. 2B, which shows additional detail of the lower grillage (202). The lower grillage (202) shown in FIG. 2B is only an example of a frame suitable for serving as the lower grillage (202). Many variations are possible, including changes to size, shape, dimensions, number of connecting components, etc. However, any lower grillage (202) will have components for holding the mast (204), components for connection to a hydraulic piston (e.g., hydraulic piston (208)), and one or more braces and sliders for securing the lower grillage (202) in a slidable relationship with respect to the interior walls of a building or some other support. The components for holding the mast, the components for holding the hydraulic piston, and the braces and sliders are all connected to each other, at least indirectly.

In the variation shown in FIG. 2B, the lower grillage (202) includes a first girder (220) and a second girder (222). The first girder (220) is connected to the second girder (222) via one or more cross girders, such as main cross girder (224) and secondary cross girder (226). Together, the girders and cross girders provide a framework to which the mast (204) of a crane may be attached. The girders and cross girders are sized, dimensioned, and connected to each other in a manner such that the lower grillage (202) may bear the weight of some or all of the crane.

The lower grillage (202) is connected to one or more piston supports, such as piston support (228). The piston support (228) is a girder or some other object configured to bear at least some of the weight of the crane. In the example of FIG. 2B, two piston supports are shown on opposite sides of the lower grillage (202). Each piston support may include one or more piston mounts. Thus, piston support (228) may include connection mount (230), along with a second connection mount on an opposing end of the piston support (228). Accordingly, in the example of FIG. 2B, the lower grillage (202) is configured to mount four hydraulic pistons to the lower grillage (202), one at each opposed end of the two piston supports.

The lower grillage (202) includes one or more rollers, such as side roller (232) and end roller (234). In the example of FIG. 2A, four side rollers are shown, two on each side of the lower grillage (202), and four end rollers are shown, two on each end of the lower grillage (202).

The rollers may be mounted to arms which, in turn, are mounted to the first girder (220) and/or the second girder (222). Thus, for example, the side roller (232) is connected to a side arm (236), which is connected to the first girder (220). The end roller (234) is connected to an end roller (234), which is connected to the second girder (222). Each arm may be a telescoping arm. Thus, for example, the length of an arm may be adjusted so that the corresponding roller will be pressed up against the internal walls of a building, or to some other support, when a lift operation is taking place.

One or more lower grillage mounting braces, such as lower grillage mounting brace (240), are connected to the lower grillage (202). Each lower grillage mounting brace may be secured to the internal walls of a building or to some other support. Thus, some or all of the weight of the crane may be borne by the lower grillage (202) when the lower grillage mounting brace (240) and other lower grillage mounting braces are connected to the internal walls of the building or to some other support.

In one embodiment, the lower grillage mounting brace (240) and other lower grillage mounting braces may be at least partially retracted or turned to one side. When retracted or turned, the end rollers (e.g., end roller (234)) may slide along the internal walls of the building or other support when a lift operation is taking place. In other words, when the lower grillage mounting brace (240) is connected to the internal walls of the building or other support, the lower grillage (202) is secured and bears the load of the crane. When the lower grillage mounting brace (240) is retracted or disengaged, the lower grillage (202) may slide along the internal walls of the building via the end rollers, such as during a lifting operation.

FIG. 2C shows a plan view of the lower grillage (202) in the context of the interior walls of a building (242) that is under construction. The first girder (220), second girder (222), main cross girder (224), secondary cross girder (226), piston support (228), connection mount (230), side roller (232), end roller (234), side arm (236), end arm (238), and lower grillage mounting brace (240) are shown for reference.

Insets, such as inset (244), are disposed in opposed sides of the building (242). As can be seen, the lower grillage mounting brace (240) is placed within and rests on the inset (244). Thus, when the lower grillage mounting braces (e.g. lower grillage mounting brace (240)) are engaged in the insets (e.g., the inset (244)), the weight of the lower grillage (202) and the mast may be borne by the walls of the building (242). However, the lower grillage mounting brace (240) is disengaged, the lower grillage (202) may slide along the internal walls of the building via the rollers, such as the side roller (232) and the end roller (234). Operation of these components is described with respect to FIG. 3A through FIG. 3C.

Attention is now turned to FIG. 2D, which shows details of the climbing frame (206) also shown in FIG. 2A. Like the lower grillage (202), the climbing frame (206) is designed to be affixable to the internal walls of a building or other support, and to be disengaged from the internal walls or other support.

Thus, the climbing frame (206) has one or more feet, such as foot (246). The foot (246) is configured to be placed onto a support, such as the inset (244) of a building shown in FIG. 2C. Thus, in an engaged position, the feet may be used to support the weight of the climbing frame (206) using the internal walls of a building, or some other support.

The feet are retractable. Thus, for example, the foot (246) has a retracted position. When retracted, the climbing frame (206) may slide upwardly and downwardly along the inside walls (e.g., an elevator shaft in which the crane is placed).

The feet are connected to climbing frame girders, such as climbing frame girder (248). The climbing frame girders are connected to each other via one or more cross beams, such as cross beam (250).

The climbing frame girders also include one or more piston attachment points, such as piston attachment point (252). The piston attachment point (252) is configured to allow a hydraulic piston to be connected to the climbing frame girder (248). In the example shown in FIG. 2D, two piston attachment points are provided on each of two climbing frame girders (and a foot is provided on each end of the climbing frame girders).

One or more inner arms, such as inner arm (254), are attached to the climbing frame girders and/or to the cross beams. In the example of FIG. 2D, two inner arms are attached to climbing frame girder (248) and two more inner arms are attached to the opposing climbing frame girder. Additionally, two inner arms are attached to the cross beam (250) and two more inner arms are attached to the opposing cross beam, such that eight inner arms in all extend towards a central region (256) of the climbing frame (206). In use, the mast of the crane is disposed in the central region (256).

While not shown in FIG. 2D, one or more outer arms may extend from the climbing frame girder (248), opposed to the direction the inner arm (254) extends from the climbing frame girder (248). Thus, referring to FIG. 2B, an arm such as side arm (236) may extend outwardly from the climbing frame girder (248) and/or from the opposing climbing frame girder. Accordingly, it is possible for outer arms with rollers and/or engagement elements to extend outwardly to a wall, insert, support, etc. Such additional outer arms allow for additional stability for the crane mast disposed in the central region (256).

One or more rollers are attached to distal ends of the inner arms. For example, inner arm roller (258) is attached to a distal end of the inner arm (254). In use, the mast of the crane may roll along the rollers when either the mast is moved through the central region (256) during a crane lift operation, or when the climbing frame (206) is lifted to a higher elevation in preparation for a future lift operation. Note that in some embodiments, a gap may be present between the mast of the crane and one or more of the inner arm rollers. The operational use of the climbing frame (206) is described further with respect to FIG. 3A through FIG. 3C.

In use, the climbing frame girder (248) and foot (246) are oriented perpendicularly to the first girder (220) and the second girder (222) of the lower grillage (202). The climbing frame girder (248) and foot (246) are also oriented perpendicularly to the upper grillage girder (262) and upper grillage foot (264) of the upper grillage (218), as shown in FIG. 2F below. This arrangement is also seen in FIG. 2A.

The climbing frame (206) shown in FIG. 2D may be varied. For example, the foot (246) and/or other feet may be oriented in some other orientation, such as parallel to the climbing frame girder (248) or at an angle with respect to the climbing frame girder (248). The type of foot shown may be varied. The climbing frame girder (248), cross beam (250), and other components may have different shapes or may have more or fewer components or subcomponents. Thus, the example shown in FIG. 2D does not necessarily limit the one or more embodiments.

FIG. 2E shows a plan view of the climbing frame (206) in the context of the interior walls of a building (242) that is under construction. The lower grillage (202) and inset (244), shown for reference, are located underneath the climbing frame (206). Also shown for reference are the foot (246), climbing frame girder (248), cross beam (250), inner arm (254), central region (256), and inner arm roller (258).

In FIG. 2E, the foot (246) is disposed on an anchor point (260). The anchor point (260) is part of a building, such as another inset provided on the inside walls of a building, but may be some other support. When the feet are engaged, the feet are disposed in the anchor points. Thus, during a crane lift operation, the weight of the crane and of the device (200) is supported by the anchor points.

Attention is turned to FIG. 2F, which shows details of the upper grillage (218). The upper grillage (218) may be optional in some embodiments.

The upper grillage (218) is defined by one or more upper grillage girders, such as upper grillage girder (262). The example of FIG. 2F includes two upper grillage girders.

Each upper grillage girder has one or more upper grillage feet, such as upper grillage foot (264), that extend from the end(s) of the upper grillage girders. In use, the upper grillage feet are configured to engage with additional anchor points present in the inner walls of a building, or with some other support.

One or more cross beams may connect the upper grillage girders, such as central cross beam (266) and outer cross beam (268). In an embodiment, the central cross beam (266) may be thicker than the outer cross beam (268). The upper grillage girders and central cross beams define a central region (270). In use, the mast of the crane is disposed through the central region (270).

Inner rollers may be connected to the central cross beams and to the girders, facing inwardly towards the central region (270). Thus, for example, inner roller (272) may be connected to the central cross beam (266) and face towards the central region (270). In use, the mast of the crane may roll along the rollers as the crane passes through the central region (270) during a phase of a crane lift operation, as described with respect to FIG. 3C. As with the case described above, in some cases, a gap may be present between the mast of the crane and the inner rollers.

However, connectors, such as connector (280), may be attached to the upper grillage girders and the central cross beams. The connectors are configured to be removably connected to the mast of the crane so that, during another phase of a crane lift operation as shown in FIG. 3B, the upper grillage (218) is fixed to the mast.

In addition, one or more outer arms extend outwardly from the upper grillage girders. Thus, for example, outer arm (274) extends outwardly from upper grillage girder (262). In the example of FIG. 2F, two outer arms extend outwardly from each of the two upper grillage girders.

Rollers are connected to the distal ends of the outer arms. Thus, for example, outer roller (276) is connected to the distal end of the outer arm (274). In the example of FIG. 2F, one corresponding roller (formed from a pair of wheels) is connected to each of the four outer arms. In use, the rollers roll along the inner walls of a building under construction (e.g., in an elevator shaft) or some other support while the upper grillage (218) is being lifted.

Additional rollers may be present on or adjacent to the feet. Thus, for example, foot roller (282) is disposed below and to a side of the foot (284) shown in FIG. 2F. Note that the foot roller (282) is connected to a second upper grillage girder (262B), which is opposed to the upper grillage girder (262), and thus is not necessarily part of the assembly that forms the foot (284). Additionally, a foot press (286) may be attached to and extend from the second upper grillage girder (262B) (or from the assembly that forms the foot (284)).

In use, the foot roller (282) rolls along the internal wall of a building or along some other support while the upper grillage (218) is being lifted. However, when the upper grillage (218) is to be locked in place (such as when the feet are engaged in an inset of the wall of a building or engaged with some other support), then the foot press (286) may be engaged against the wall or support. Accordingly, the foot press (286) further secures the upper grillage (218) to the internal wall of the building, or other support.

FIG. 2G shows a plan view of the upper grillage (218) in the context of the interior walls of a building (242) that is under construction. The upper grillage girder (262), upper grillage foot (264), central cross beam (266), outer cross beam (268), central region (270), inner roller (272), outer arm (274), and outer roller (276), and connector (280) are shown for reference.

The upper grillage (218) as shown in FIG. 2G is anchored to opposed second insets, such as second inset (278), disposed in the inside walls of the building (242). In particular, the upper grillage foot (264) is disposed in the inset, thereby anchoring the upper grillage to the building (242).

In use, during a lift operation, the upper grillage (218) will move with the mast of the crane. Thus, prior to the lift operation, the connector (280) and other connectors are connected to the mast of the crane. Thereafter, the upper grillage foot (264) and other feet are retracted from the insets of the building, thereby transferring the load of the upper grillage (218) to the mast of the crane (and thence to one or more grillages disposed below or above the upper grillage (218)). Thus, when the crane is lifted, the upper grillage (218) lifts with the mast of the crane. After the lift operation is completed, the upper grillage foot (264) and other feet are engaged with the building (242) at a higher elevation. An example of the lifting operation is shown in FIG. 3A through FIG. 3C.

FIG. 3A, FIG. 3B, and FIG. 3C pictorially illustrate a method for lifting a crane under a tension load, in accordance with one or more embodiments. In the example of FIG. 3A through FIG. 3C, reference numerals from FIG. 2A through FIG. 2G are repeated. Thus, for example, the lower grillage (202), the climbing frame (206), and the upper grillage (218) described with respect to FIG. 2A through FIG. 2G are all shown in FIG. 3A through FIG. 3C. Thus, reference numerals in common with FIG. 2 have similar names and similar descriptions in FIG. 3A through FIG. 3C. FIG. 3A through FIG. 3C should be read together as a whole.

Attention is first turned to FIG. 3A. Preparation for lifting a crane (300) has already been performed. For example, crew and equipment has been secured and the crane (300) is ready for lifting. The crane (300) is disposed inside an elevator shaft of a building (242) under construction. The walls of the building (242) will ultimately bear the weight of the crane (300).

Initially, the lower grillage (202) is connected to opposed insets (see inset (244) in FIG. 2C) in the building (242) walls. The opposed insets are not visible in FIG. 3A through FIG. 3C, as they are disposed inside the page and outside the page, though the opposed insets are visible in FIG. 2C. Thus, the weight of the crane (300) could be borne by the lower grillage (202), which could transfer the load to the walls of the building (242).

Then, the climbing frame (206) is connected to additional opposed insets, such as inset (244), in the building (242). Thus, the climbing frame (206) is also initially anchored to the building (242). Additionally, the upper grillage (218) is fixed to the mast of the crane (300).

As can be seen in FIG. 3A, one or more hydraulic pistons, such as hydraulic piston (212), are connected to the lower grillage (202) and to the climbing frame (206). In the example shown, the hydraulic piston (212) body is connected to the lower grillage (202) and the support rod (216) of the hydraulic piston (212) is connected to the climbing frame (206). Referring to FIG. 2B, the hydraulic piston (212) body is connected to a connection mount, such as the connection mount (230). Referring to FIG. 2D, the support rod (216) is connected to a piston attachment point, such as the piston attachment point (252).

The hydraulic pistons are oriented such that the support rods and the hydraulic pistons will be under a tension load when the crane is ultimately lifted. However, the support rods may still be extended to apply a compression load on the climbing frame (206), as will be described with respect to a third climbing phase shown FIG. 3C.

The climbing operation begins by partially loading the climbing frame (206) and hydraulic cylinders to allow for retraction of the feet. Then the climbing operation includes retracting the feet of the lower grillage (202) and upper grillage (218) from the insets (again shown in FIG. 2C) in the building (242). When the feet of the lower grillage (202) are retracted from the insets, the weight of the crane (300) is transferred to the climbing frame (206). The walls of the building (242) continue to bear the load of the assembly, though now starting from an elevated height relative to the position of the lower grillage (202).

Next, as shown in FIG. 3B, the hydraulic pistons pull upwardly, drawing the lower grillage (202) towards the climbing frame (206). The crane (300) passes through the climbing frame (206), rolling along the inner arm rollers (e.g., inner arm roller (258)) shown in FIG. 2D. The inner arm rollers help keep the crane (300) from tipping during the lift operation.

Additionally, because the upper grillage (218) is also attached to the mast of the crane (300), the upper grillage (218) is likewise pushed upwardly. The outer rollers (e.g. outer roller (276)) of the upper grillage (218) roll against the inside walls of the building (242). The outer arms (e.g. outer arm (274)) of the upper grillage (218) are spaced so as to stabilize the mast of the crane (300) so that the mast of the crane (300) is inhibited from tipping during the lift operation.

By pulling the lower grillage (202) towards the climbing frame (206), the weight of the crane (300) is borne as a tension load by the hydraulic pistons. As a result, the support rods (e.g. support rod (216)) are unlikely to buckle or cannot buckle. Hence the length of the stroke of the hydraulic pistons may be increased, relative to using the hydraulic pistons to push the crane (300) upwardly under a compression load. Because the stroke length is increased, fewer lift operations are required to lift the crane (300), thereby saving considerable money and time (e.g., days in some cases) during a major building construction project.

When the lift is completed, the lower grillage (202) and upper grillage is once again secured to insets in the inner walls of the building (242). Thus, the lower grillage and upper grillage (202) may now once again bear the load of the crane (300). The feet of the climbing frame (206) are retracted, thereby transferring the load of the crane (300) to the lower grillage (202) and thence to the inner walls of the building (242).

In order to prepare for a future lift operation, the feet of the climbing frame (206) are disengaged from the insets in the inner walls of the building (242) and raised to the next set of insets. The lower grillage (202) remains anchored to insets in the inner walls of the building (242).

The hydraulic pistons are now engaged again, but this time apply a compression load to the climbing frame (206). The climbing frame weighs much less than the combination of the crane (300), the lower grillage (202), the climbing frame (206), and the upper grillage (218). Thus, buckling of the support rods is not likely to be a concern.

As a result of engaging the hydraulic pistons and applying a compression load to the climbing frame (206), the climbing frame (206) is pushed upwardly, as shown in FIG. 3C. The inner arm rollers (e.g. the inner arm rollers (258) shown in FIG. 2D) roll along the mast of the crane (300) as the climbing frame (206) is lifted upwardly. The climbing frame (206) is lifted to a new desired height, where there are additional insets in the inner walls of the building (242). The feet of the climbing frame (206) may then be engaged with the new insets. The crane climbing or lifting operation may then repeat as desired.

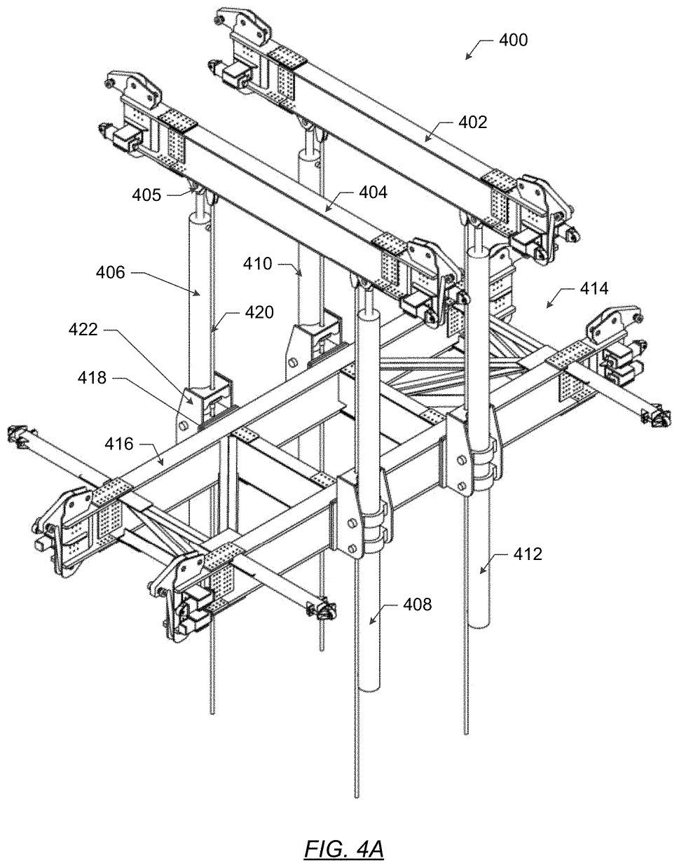

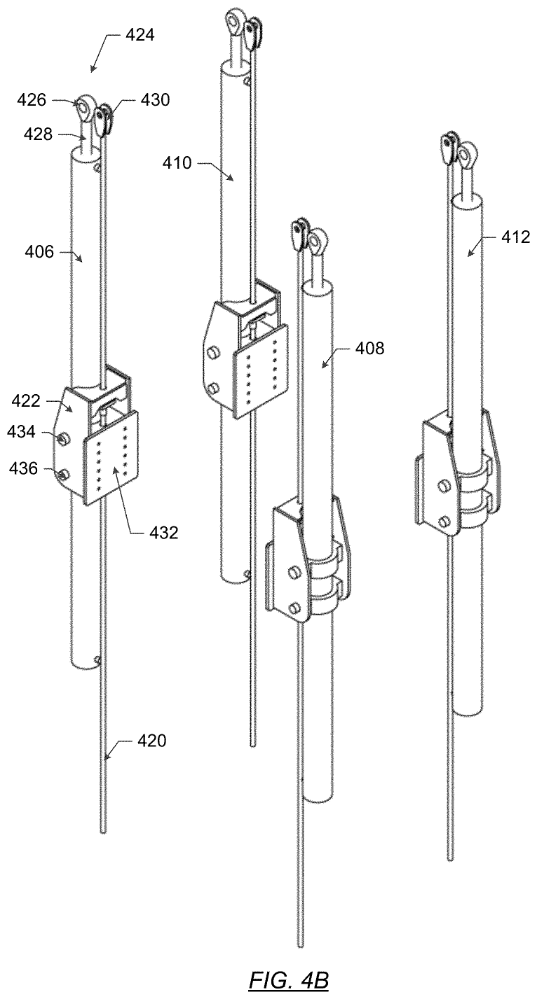

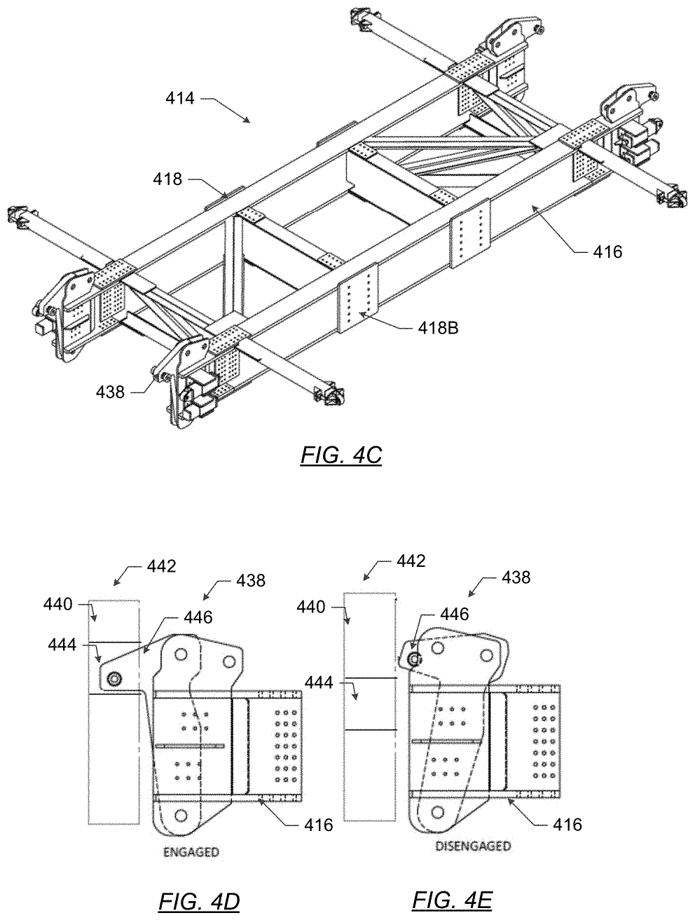

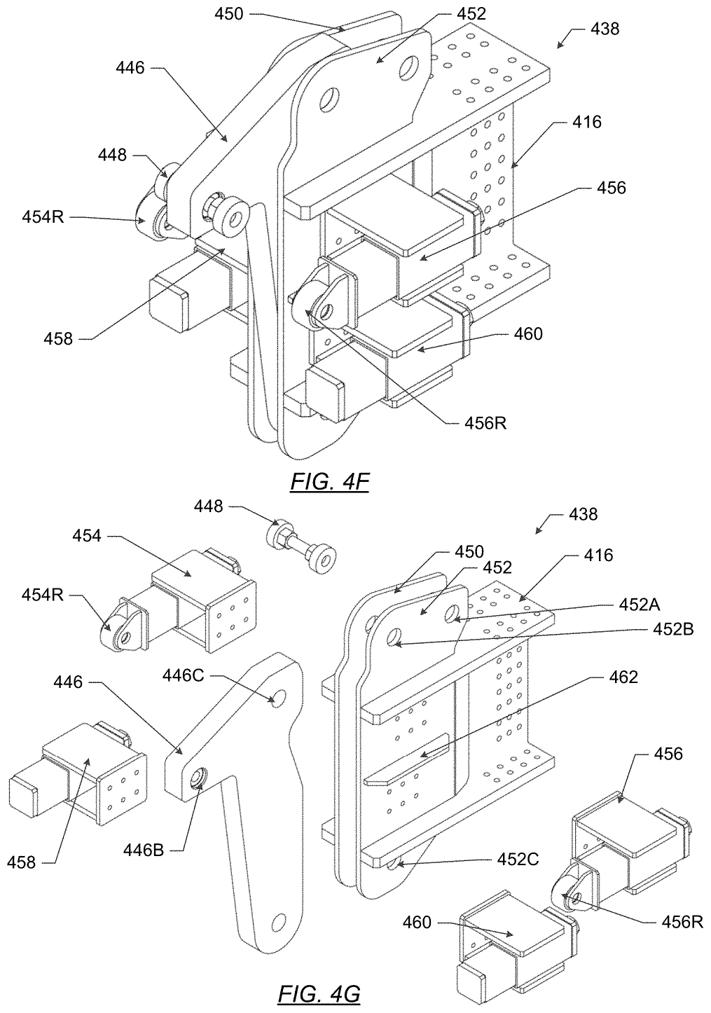

FIG. 4A, FIG. 4B, FIG. 4C, FIG. 4D, FIG. 4E, FIG. 4F, and FIG. 4G show different aspects of another device for lifting a crane, in accordance with one or more embodiments. The embodiment shown in FIG. 4A through FIG. 4G optionally may operate in conjunction with an upper grillage, such as upper grillage (218) in FIG. 2A. In FIG. 4A through FIG. 4G, common reference numerals refer to similar objects having similar descriptions.

The device (400) of FIG. 4A through FIG. 4G differs from the example of FIG. 2A through FIG. 2G in a number of respects. For example, the climbing frame (206) of FIG. 2A through FIG. 2G is replaced by one or more climbing beams, such as first climbing beam (402) and second climbing beam (404). In the example of FIG. 2A through FIG. 2G, the climbing frame girders of the climbing frame were connected via cross beams, but in the example of FIG. 4A, the first climbing beam (402) and the second climbing beam (404) are not directly connected. Rather the hydraulic pistons (e.g., first hydraulic piston (406), second hydraulic piston (408), third hydraulic piston (410), and third hydraulic piston (412)) connect the climbing beams to the lower grillage (414). Specifically, the first hydraulic piston (406) and the second hydraulic piston (408) connect the lower grillage (414) to the second climbing beam (404) via one or more connection mounts, such as connection mount (405). The connection mounts are bolted or otherwise connected to the climbing beams, or integrally formed with the climbing beams. The third hydraulic piston (410) and the third hydraulic piston (412) connect the lower grillage (414) to the first climbing beam (402).

Another difference is that the hydraulic pistons are connected directly to the main girders of the lower grillage (414) at mounting plates, rather than to piston supports that are connected to the girders of the lower grillage, as shown in FIG. 2B. Thus, for example, the first hydraulic piston (406) is connected to a first main girder (416) of the lower grillage (414) at a first mounting plate (418).

Yet another difference is that a corresponding secondary rod is provided together with each of the hydraulic pistons. For example, secondary rod (420) is connected to the second climbing beam (404) and disposed parallel to the first hydraulic piston (406). The secondary rods and the hydraulic pistons together are disposed through and connected to support frames that, in turn, connect to the mounting plates. Thus, for example, the first hydraulic piston (406) and the secondary rod (420) are both disposed through and are connected to a support frame (422). In turn, the support frame (422) connects to the first mounting plate (418) of the lower grillage (414).

In use, the secondary rods provide for a redundant support between the climbing beams (e.g., climbing beam (402) and climbing beam (404)) and the support frames (e.g., support frame (422)). Thus, in the event that a hydraulic piston, such as first hydraulic piston (406), no longer supports the weight of the lower grillage (414) or the crane mast, the corresponding secondary rod will accept the load. Accordingly, the secondary rods provide redundant support for loads borne by the hydraulic pistons.

In an embodiment, the secondary rods may be threaded or partially threaded. During a lift operation, a nut (not shown) within the support frame (422) may spin, thereby increasing the height of the nut on the secondary rod. The nut may provide additional support in that the nut has a diameter greater than the hole in the support frame (422) through which the support rod (420) is disposed.

FIG. 4B through FIG. 4G show additional details of the components of the device (400) shown in FIG. 4A. FIG. 4B shows details of the assemblies of the hydraulic pistons, the secondary rods, and the support frames. For example, assembly (424) includes the first hydraulic piston (406), secondary rod (420), and support frame (422). The other hydraulic pistons, second hydraulic piston (408), third hydraulic piston (410), and third hydraulic piston (412), are also shown for reference.

Pin mounts are provided at ends of the hydraulic pistons and the secondary rods for connection to the climbing beams (e.g., climbing beam (404) in FIG. 4A). Thus, for example, a rod pin mount (426) is disposed on one end of a piston rod (428) of the first hydraulic piston (406). Similarly, a secondary rod pin mount (430) is disposed on one end of the secondary rod (420).

Additional features of the support frame (422) are also shown. For example, a support frame mounting plate (432) is attached to the support frame (422). The support frame mounting plate (432) may be connected to the first mounting plate (418) shown in FIG. 4A, thereby connecting the assembly (424) to the lower grillage (414).

The support frame (422) may be reinforced by means of a load bearing pin (434) and a stabilizing pin (436). The load bearing pin (434) may be welded to the first hydraulic piston (406) during fabrication of the assembly (424), thereby connecting the first hydraulic piston (406) to the assembly (424). The stabilizing pin (436) also is disposed through the side plates of the support frame (422) and welded to the first hydraulic piston (406), but may bear less load when in use. The stabilizing pin (436) provides additional stabilization of the first hydraulic piston (406) within the support frame (422).

As indicated above, the secondary rod (420) is disposed parallel to the first hydraulic piston (406). The secondary rod (420) is further disposed through the support frame (422) together with the first hydraulic piston (406).

In use, the secondary rod pin mount (430) may be first connected to the second climbing beam (404) shown in FIG. 4A. The rod pin mount (426) is connected to a connection mount, such as connection mount (405) in FIG. 4A. The assembly (424) is then connected to the lower grillage (414) via the support frame mounting plate (432). However, in different embodiments, the above-recited order of operations may be varied.

Attention is now turned to FIG. 4C, which shows details of the lower grillage (414) shown in FIG. 4A. The lower grillage (414) shows many similar components and features of the lower grillage (202) shown in FIG. 2B, and such similar features are not described again with respect to the lower grillage (414) of FIG. 4C.

However, several differences are called out in the lower grillage (414) of FIG. 4C, relative to the lower grillage (202) of FIG. 2B. For example, as indicated above in the description of FIG. 4A, a first mounting plate (418) is attached to the first main girder (416). The first mounting plate (418) is used to connect the first hydraulic piston (406) to the lower grillage (414). Specifically, the first mounting plate (418) and the support frame mounting plate (432) are sized and dimensioned to be placed in a flush relationship with each other, and bolt holes are placed in the two mounting plates in a matching alignment for ease of connection of the two mounting plates. Details of the first mounting plate (418) are shown at second mounting plate (418B) in FIG. 4C.

Another difference is that the proximal and distal ends of the main girders are fitted with flipper assemblies. For example, a first flipper assembly (438) is connected to one end of the first main girder (416). Details of the first flipper assembly (438) and other flipper assemblies are shown with respect to FIG. 4D through FIG. 4G.

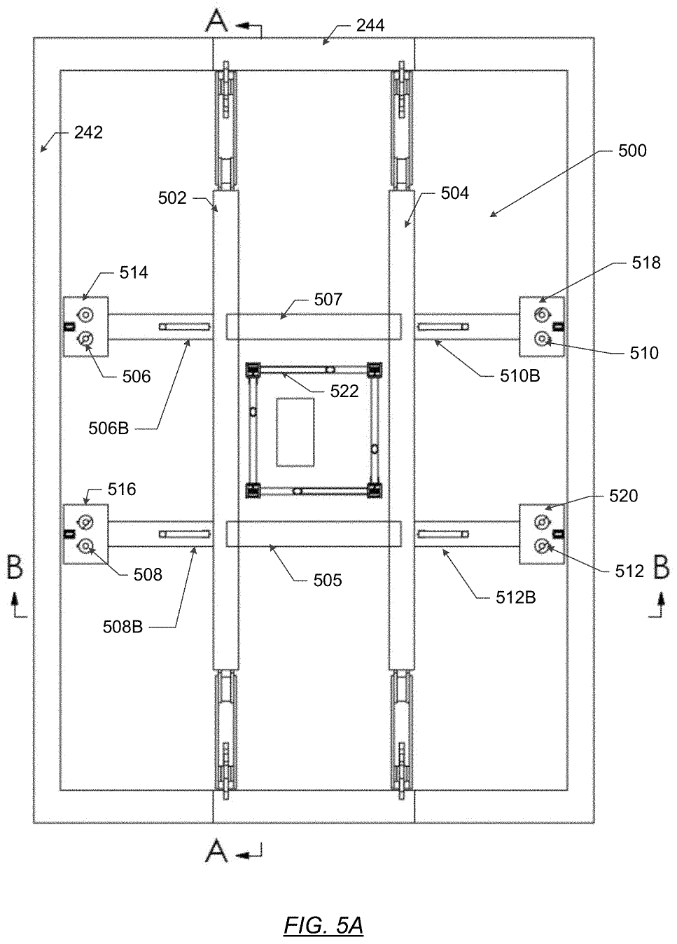

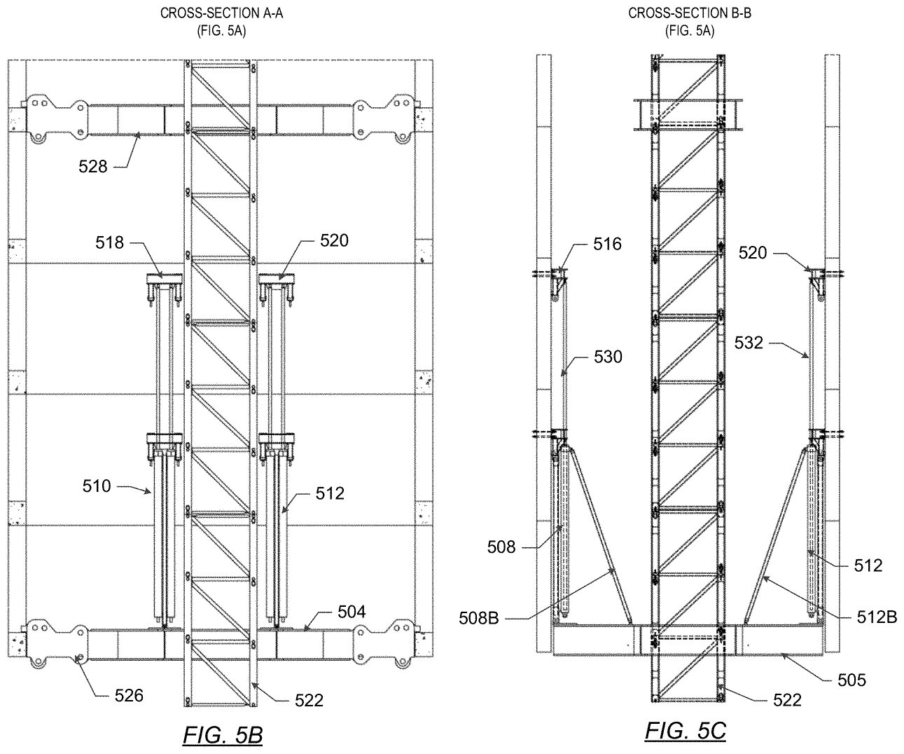

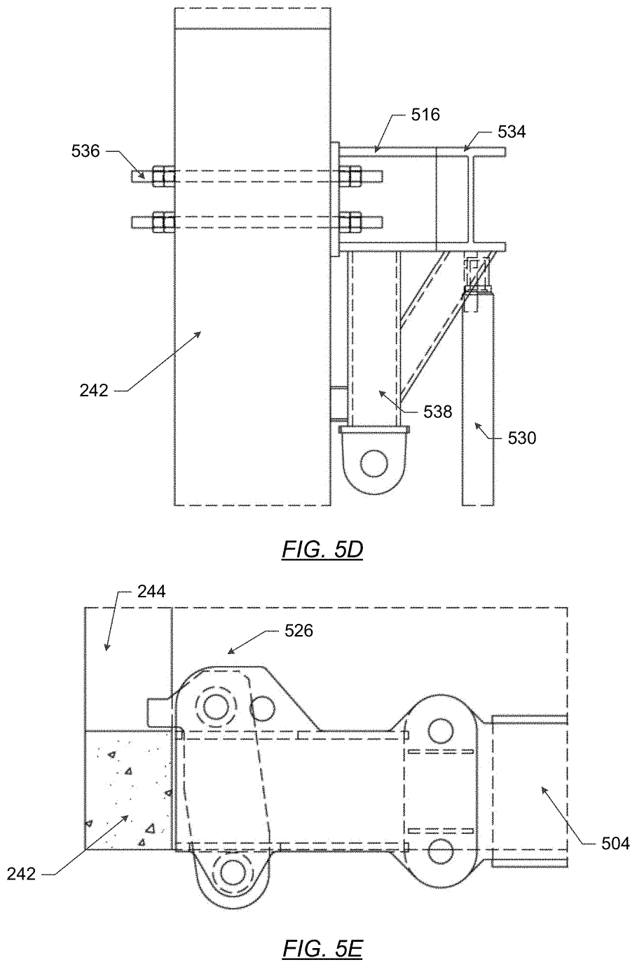

The flipper assemblies are used during a climbing operation. In particular, in use, the flipper assembly snaps into an inset in the inside walls of a building (e.g., inset (244) of building (242) in FIG. 2C) or other support when the first main girder (416) is elevated to the level of the inset. However, between insets at different elevations, the first flipper assembly (438) is pushed proximally (i.e., towards the other end of the first main girder (416)) so that the first main girder (416) is free to be pushed along the inside walls of the building. This operation is described with respect to FIG. 5A through FIG. 5D.

Attention is now turned to FIG. 4D through FIG. 4G, which show details of the first flipper assembly (438) shown in FIG. 4C. The first flipper assembly (438) is shown with respect to a wall (440) of a building (442).

In FIG. 4D, the first flipper assembly (438) is shown engaged with an inset (444) of the wall (440). In particular, the hammer head (446) of the first flipper assembly (438) is engaged within the inset (444). However, when the first main girder (416) is raised upwardly during a lift operation, the hammer head (446) is drawn back in the direction of the first main girder (416), as shown in FIG. 4E. As a result, the first main girder (416) is now free to move upwardly and downwardly along the wall (440) of the building (442).

Attention is now turned to FIG. 4F and FIG. 4G, which show additional details of the first flipper assembly (438). FIG. 4F shows a perspective view of the first flipper assembly (438) and FIG. 4G shows an explode view of the first flipper assembly (438) shown in FIG. 4F. FIG. 4F and FIG. 4G are described together and should be viewed together.

The hammer head (446) shown in FIG. 4D and FIG. 4E is also shown in FIG. 4F and FIG. 4G. A load bolt (448) is disposed through a hole in the distal portion of the hammer head (446). The load bolt (448) may be used to push on the internal wall of a building, or other support, to resolve a horizontal load from the crane.

The first retaining plate (450) and second retaining plate (452) may be provided with bolt holes, such as bolt hole (452A), bolt hole (452B), and bolt hole (452C) through the second retaining plate (452). The bolt holes allow one or more bolts or pins to be disposed through the second retaining plate (452), through the hammer head (446), and through the first retaining plate (450). In the case of bolt hole (452A) and bolt hole (452B), the presence of a bolt may act as a lock pin that retains the hammer head (446) in either the engaged position or the disengaged position (see FIG. 4D and FIG. 4E). In the case of bolt hole (452C), the presence of a bolt may be permanent in order to retain the hammer head (446) between the first retaining plate (450) and second retaining plate (452). In use, the hammer head (446) will rotate about the lock pin disposed through the bolt hole (452C), through the bottom portion of the hammer head (446), and through another bolt hole on the opposite first retaining plate (450).

The first flipper assembly (438) may also be provided with one or more roller assemblies. In the example of FIG. 4A through FIG. 4G, two roller assemblies are present: first roller assembly (454) and second roller assembly (456). The two roller assemblies are connected to the first main girder (416) via mounting plates. The first roller assembly (454) and the second roller assembly (456) are configured to extend inwardly to a disengaged state and outwardly to an engaged state.

In addition, two press assemblies are present: first press assembly (458) and second press assembly (460). The two press assemblies are connected to the first main girder (416) via mounting plates. The first press assembly (458) and the second press assembly (460) are configured to extend inwardly to a disengaged state and outwardly to an engaged state.

In use, the first roller assembly (454) and the second roller assembly (456) have opposite engaged and disengaged states relative to the first press assembly (458) and the second press assembly (460). Thus, for example, when the first roller assembly (454) is engaged, the first press assembly (458) is disengaged, and vice versa. When the climbing beam is being lifted or is otherwise moving, the two roller assemblies are in the engaged state, but the two press assemblies are in the disengaged state. When the climbing beam is secured to the internal walls of a building or to some other support, the two press assemblies are in the engaged state, but the two roller assemblies are in the disengaged state. In this manner, additional stability is provided to the climbing beam during either a lift operation or while the climbing beam is to bear a load.

In an embodiment, a flange (462) may be disposed on the second retaining plate (452) and a corresponding, opposed flange disposed on the first retaining plate (450). The flange (462) serves as a separator between the roller assemblies placed on the same retaining plate. The flange (462) may also serve as a guide in placing a roller assembly on the retaining plate during assembly of the first flipper assembly (438).

In use, the hammer head (446) is engaged in the position shown in FIG. 4F, with a lock pin driven through the bolt hole (452B) and through a rear hole (446C) in the hammer head (446). The pin serves as a lock pin to lock the hammer head (446) in the engaged position. The load bolt (448) is disposed through a forward hole (446B) in the hammer head (446). Again, the load bolt (448) helps resolve a horizontal load from the crane while the hammer head (446) is in the engaged position.

However, when the first main girder (416) is to be disengaged from the inset, the lock pin is removed from the bolt hole (452B). The hammer head (446) is pulled back. The lock pin then is placed through the bolt hole (452A) and through rear hole (446C) in the hammer head (446). As a result, the hammer head (446) is retained in the disengaged position.

The first main girder (416) is then ready to be lifted along the inner walls or other support of the building to a new inset. Thereafter, the process is reversed and the hammer head (446) placed into the engaged position in the new inset. Accordingly, the first main girder (416) is secured to the inner wall of the building and ready to carry the load of the crane.

FIG. 5A, FIG. 5B, FIG. 5C, FIG. 5D, and FIG. 5E show different aspects of another device for lifting a crane, in accordance with one or more embodiments. In particular, FIG. 5A through FIG. 5E use the first climbing beam (402) shown in FIG. 4A through FIG. 4G, but in a different arrangement of components to accomplish the crane lift operation in a different manner. In the example of FIG. 5A through FIG. 5E, the hydraulic pistons are connected to climbing beams in a different manner than that shown in FIG. 4A through FIG. 4G.

FIG. 5A shows the device (500) from an overhead, plan view. In the example of FIG. 5A, the device (500) includes one or more climbing beams, such as first climbing beam (502), second climbing beam (504), third climbing beam (505), and fourth climbing beam (507). Additional climbing beams may be present, as shown in FIG. 5B. The climbing beams are similar to the first climbing beam (402) or second climbing beam (404) shown in FIG. 4A.

The device (500) also includes four sets of pistons, including first piston set (506), second piston set (508), third piston set (510), and fourth piston set (512). Each piston set includes one or more pistons. In the example of FIG. 5A, each piston set includes two hydraulic pistons.

Each of the sets of pistons is connected to one of the lower climbing beams and to a piston wall mount. In particular, the first piston set (506) is connected to a first piston wall mount (514), and is connected to the first climbing beam (502) via a first brace (506B). The second piston set (508) is connected to a second piston wall mount (516), and is connected to the first climbing beam (502) via a second brace (508B). The third piston set (510) is connected to a third piston wall mount (518), and is connected to the second climbing beam (504) via a third brace (510B). The fourth piston set (512) is connected to a fourth piston wall mount (520), and is connected to the second climbing beam (504) via a fourth brace (512B). The arrangement is also shown in the combination of FIG. 5B and FIG. 5C.

The flipper assemblies of the climbing beams are removably engageable with the insets in the walls of the building. Thus, for example, the flipper assemblies on one side of the first climbing beam (502) and of the second climbing beam (504) initially are engaged in the inset (244) of the building (242). The flipper assemblies on the opposite sides of the climbing beams are likewise initially connected to an opposing inset in the building (242).

The device (500) is connected to a mast (522). In particular, the first climbing beam (502) and the second climbing beam (504) are directly connected to the mast (522), as also shown in FIG. 5B and FIG. 5C.

Additional details regarding the components shown in FIG. 5A are shown in FIG. 5B through FIG. 5E. FIG. 5B shows the section A-A, as indicated by the vertical dashed line in FIG. 5A. FIG. 5C shows section B-B, as indicated by the horizontal dashed line in FIG. 5A. FIG. 5D shows the mounting arrangement for the piston sets into the building (242). FIG. 5E shows the details of the climbing beam.

Attention is first turned to FIG. 5B, which corresponds to cross-section A-A in FIG. 5A. The mast (522) of the crane and the second climbing beam (504) are shown for reference. FIG. 5B also shows that the third piston set (510) is connected to the third piston wall mount (518), and that the fourth piston set (512) is connected to the fourth piston wall mount (520). The braces connecting the piston sets are shown in FIG. 5C.

Callout (524) shows the portion of the second climbing beam (504) that is described with respect to FIG. 5E, below. The callout (524) shows the flipper assembly (526) in more detail.

FIG. 5B also shows an optional, third climbing beam (528) disposed above the second climbing beam (504). A fourth climbing beam (not shown) may also be present, opposite the third climbing beam (528), and above the first climbing beam (502) shown in FIG. 5A. The third and fourth climbing beams may be used as braces to aid in preventing the mast (522) from tipping during a lift operation.

Attention is now turned to FIG. 5C, which shows cutout B-B from FIG. 5A. In the view of FIG. 5C, the second piston set (508) and fourth piston set (512) are visible, as are the second piston wall mount (516) and fourth piston wall mount (520). FIG. 5C also shows the braces. For example, second brace (508B) connects the second piston set (508) to the third climbing beam (505), and fourth brace (512B) connects the fourth piston set (512) to the third climbing beam (505).

However, the pistons sets depend vertically from the piston wall mounts.

Thus, the piston rods, second piston rod (530) and fourth piston rod (532), are under a tension load when in use. Accordingly, when the hydraulic pistons are actuated, the hydraulic pistons pull the climbing beams and the mast (522) upwardly, thereby lifting the crane together with the climbing beams.

Attention is now turned to FIG. 5D, which shows the details of the second piston wall mount (516) in FIG. 5A through FIG. 5C. The second piston wall mount (516) includes a mount frame (534). The mount frame (534) is mounted to the wall of the building (242) via one or more bolts, such as bolt (536). The mount frame (534) is also connected to the second piston rod (530). The mount frame (534) may be connected to a reinforcement frame (538) in order to provide additional strength when the second piston rod (530) pulls on the second climbing beam (504) and the mast (522), and thereby also pulls on the mount frame (534).

Attention is now turned to FIG. 5E, which shows the details of the flipper assembly (526). As can be seen, the flipper assembly (526) is removably inserted into the inset (244) of the building (242). In use, the flipper assembly (526) is in the engaged position when disposed within the inset (244), The flipper assembly (526) is moved back to the disengaged position when the second climbing beam (504) is ready to be lifted. Additional details of the flipper assembly (526) are shown with respect to FIG. 4D through FIG. 4G.

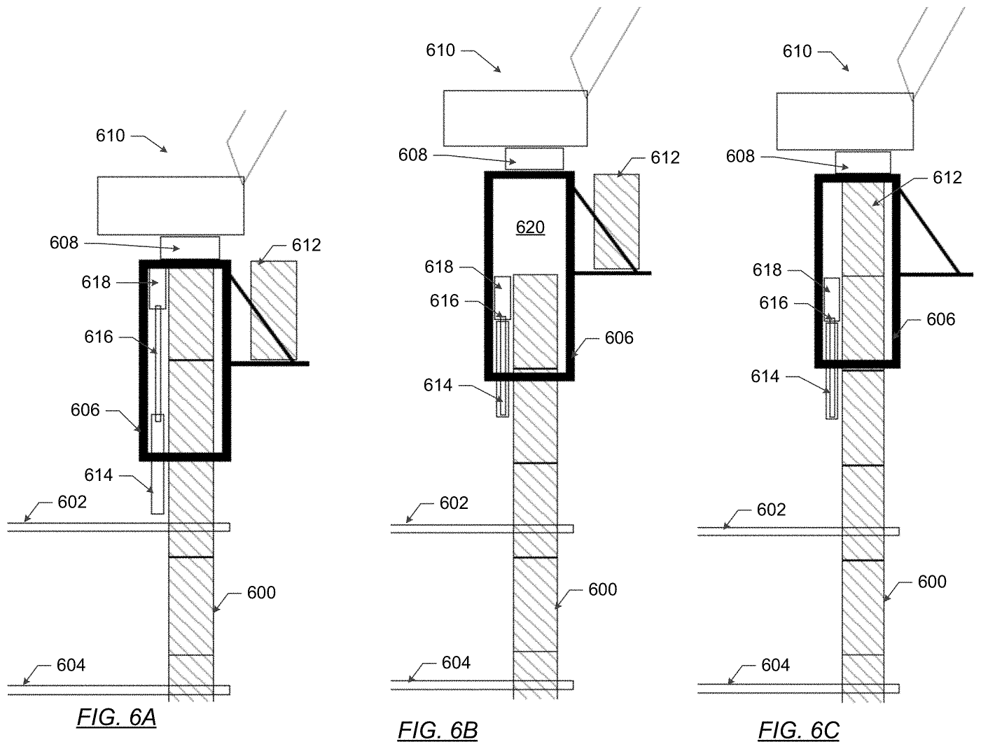

FIG. 6A, FIG. 6B, and FIG. 6C pictorially show another method for lifting a crane, in accordance with one or more embodiments. The method of FIG. 6A through FIG. 6C may be performed using a crane disposed outside a building or inside a building. The example of FIG. 6A through FIG. 6C is shown in the context of a crane having a mast (600) supported by upper support (602) and lower support (604). The supports may be attached to the building under construction (not shown) or to some other support. In the example of FIG. 6A through FIG. 6C, a cab (e.g., cab (110) in FIG. 1) is omitted for greater clarity.

Turning first to FIG. 6A, a climbing frame (606) is raised up the mast (600) until just under the turntable (608). The turntable (608) is a part of the crane that allows an apex and counter jib assembly (610) to rotate about an axis of the turntable (608). Alternatively, the climbing frame (606) is raised to a point just under some other section of the mast (600) which is to be separated for a crane lift operation.

In the example of FIG. 6A, the climbing frame (606) is connected to the turntable (608). A climbing yoke (618) is connected to a portion of the mast (600) which is to remain in place. For example, the climbing yoke (618) may be connected to a climbing lug on the top section of the mast (600), though other connection techniques may be used. In the example of FIG. 6A, the climbing yoke (618) is connected near the top of the mast (600).

A piston rod (616) of a hydraulic piston (614) is extended upwardly to a location near the top of the mast (600), just under the turntable (608), adjacent the climbing yoke (618). The piston rod (616) is connected to the climbing yoke (618). In turn, the hydraulic piston (614) is connected to the climbing frame (606).

A new mast section (612) is lifted using the apex and counter jib assembly (610) and placed on a platform of the climbing frame (606). Alternatively, the new mast section (612) otherwise may be placed in a location from which the new mast section (612) may be brought into alignment with the mast (600).

The turntable (608), now connected to the climbing frame (606), is then disconnected from the mast (600). Again, the climbing yoke (618) is fixed in place on the mast (600) and the hydraulic piston (614) is connected to the climbing frame (606).

At this point, the hydraulic piston (614) is activated. The hydraulic piston (614) is under a tension load. Thus, when the hydraulic piston (614) pulls on the climbing yoke (618), the hydraulic piston (614) draws the climbing frame (606) upwardly, thereby elevating the turntable (608) above the top of the mast (600).

FIG. 6B and FIG. 6C show the next stages of the crane lift operation. After the lift operation described above, a space (620) (FIG. 6B) is disposed between the top of the mast (600) and the turntable (608). The new mast section (612) is then moved into the space (620) (FIG. 6C). The new mast section (612) is then connected to the former top of the mast (600), and is also connected to the turntable (608). The crane is now elevated. The process may be repeated as desired to continue to elevate the crane.

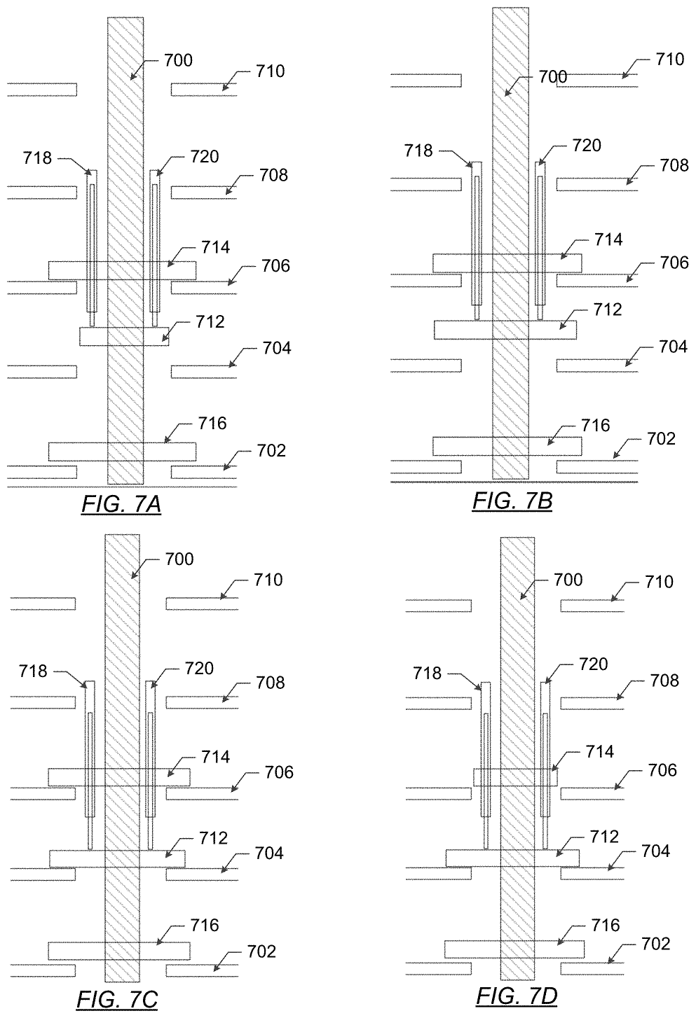

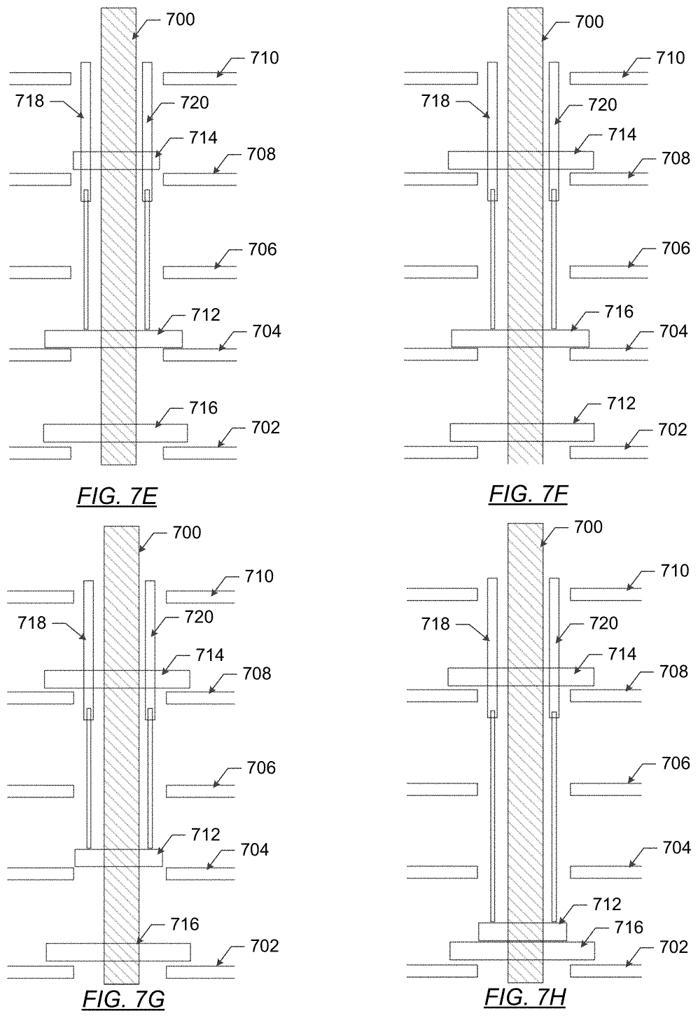

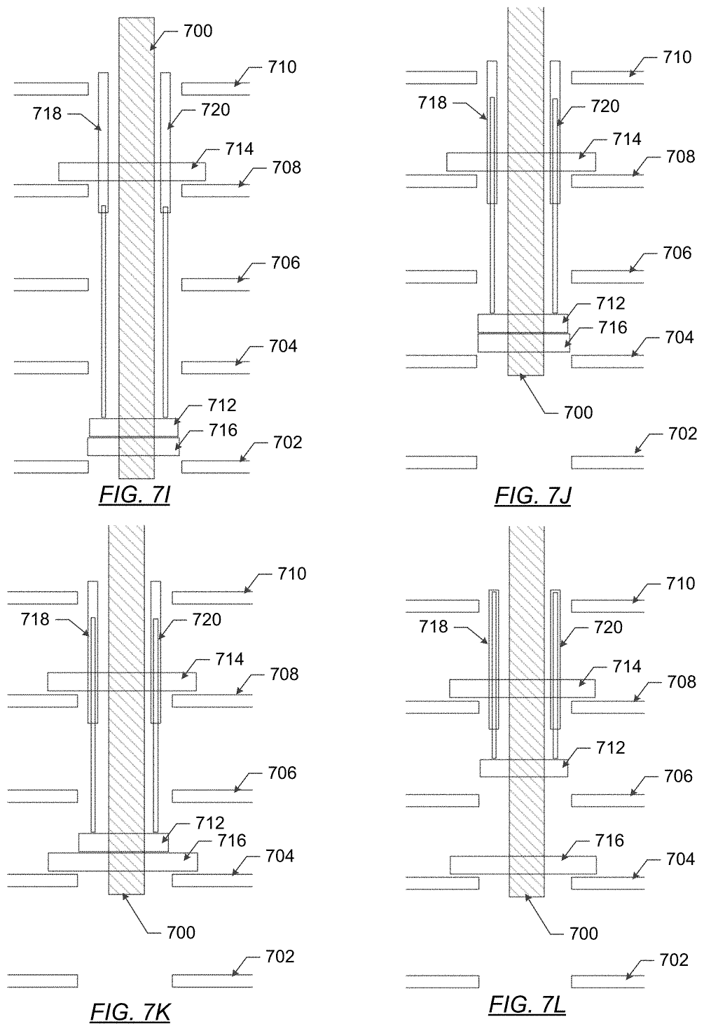

FIG. 7A through FIG. 7L pictorially show another method for lifting a crane, in accordance with one or more embodiments. The method of FIG. 7A through FIG. 7L may be accomplished using one or more climbing beams, such as first climbing beam (402) or second climbing beam (404) shown in FIG. 4A. The method of FIG. 7A through FIG. 7L is described in the context of a crane disposed inside the elevator shaft of a building or disposed inside temporary openings in the floors of a building. The floors of the building are being used to support the crane. However, the method of FIG. 7A through FIG. 7L may also be accomplished using other types of supports, such as the insets of the walls of a building as shown above, and thus the procedure of FIG. 7A through FIG. 7L is not necessarily limited to using the floors of a building.

A useful aspect of the embodiment described with respect to FIG. 7A through FIG. 7L is that, unlike other bottom climbing systems, the embodiment allows the entire climbing system and supports to move with the crane. Bottom climbing systems may use beams, or a climbing unit, that are moved separately during lifting operations. For example, the beams or climbing unit may be removed from the building, flown or otherwise moved to the next lifting levels, and re-installed. However, the embodiment of FIG. 7A through FIG. 7L allows the climbing system and supports to remain in-situ within the building, and thus can substantially decrease the time used to lift the crane relative to other lifting methods.

FIG. 7A through FIG. 7L share common reference numerals. Thus, for example, FIG. 7A through FIG. 7L refer to a mast (700) of a crane. The floors of the building, or alternatively the inserts within walls, are referred to as supports. A support has a gap (e.g., an elevator shaft) in which the mast (700) of the crane is disposed. The supports include support level (702), support level (704), support level (706), support level (708), and support level (710). The equipment used to elevate the mast (700) include a climbing frame (712), an upper collar (714), a lower collar (716), a first hydraulic piston (718), and a second hydraulic piston (720). The relationships between the components mentioned above, and their use, are described with respect to the procedure described below.

The climbing frame (712), upper collar (714), and lower collar (716) may be climbing beams, such as the first climbing beam (402) and second climbing beam (404) shown in FIG. 4A, or a climbing frame such as climbing frame (206) shown in FIG. 2D. In any case, the climbing frame (712), upper collar (714), and lower collar (716) are each extendable and retractable, or have components that are extendable and retractable. The degree of extension and retraction is not necessarily reflected proportionally to the length of the frames and collars in FIG. 7A through FIG. 7L. For example, the degree of extension and retraction may be exaggerated in order to more clearly visualize the process.

FIG. 7A shows an initial position of the lifting components with respect to the supports. The upper collar (714) is disposed in an extended position on support level (706). The lower collar (716) is disposed below on support level (702). The climbing frame (712) is in a retracted position and is suspended from the upper collar (714) and/or walls of the building and/or the supports via the first hydraulic piston (718) and the second hydraulic piston (720).

In FIG. 7B, the climbing frame (712) is extended so that the climbing frame (712) is long enough to rest on a support. Extension may be accomplished, for example, by placing a flipper assembly in an engaged position (see, e.g., FIG. 4A), or by extending feet of the climbing frame (see, e.g., FIG. 2D).

In FIG. 7C, the climbing frame (712) is pushed against the support level (704). At this time, the weight of the mast (700) and/or the rest of the crane may be supported by the upper collar (714) and the support level (706) (though some other support may also be engaged to support the mast (700)). Pushing the climbing frame (712) against the support level (704) may be accomplished by actuating the first hydraulic piston (718) and the second hydraulic piston (720). However, once the climbing frame (712) is engaged with the support level (704), then the weight of the mast (700) and/or the rest of the crane may be supported using the climbing frame (712).

In FIG. 7D, the upper collar (714) is retracted to a sufficient degree that the upper collar (714) may pass through the gaps in the supports. Retraction of the upper collar (714) may be accomplished in a manner similar to that described above using the climbing frame (712).

In FIG. 7E, the upper collar (714) is elevated to a new level, in particular just above the support level (708). The upper collar (714) may be pushed upwardly by the first hydraulic piston (718) and the second hydraulic piston (720) under a compression load. The hydraulic pistons lift the upper collar (714) under a compression load because the hydraulic pistons are oriented to lift the mast (700), at a later step, under a tension load, but such orientation may require lifting the upper collar (714) under a compression load in order to avoid having to reverse the orientation of the hydraulic pistons. However, the upper collar (714) is relatively light compared the weight of the mast (700) and/or the rest of the crane, so buckling of the piston rods of the first hydraulic piston (718) and second hydraulic piston (720) is not a concern.

In FIG. 7F, the upper collar (714) is extended into an engaged position.

Extension of the upper collar (714) may be accomplished as described above with respect to the lower collar (716). In addition, the upper collar (714) is attached to the mast (700). Thus, in subsequent steps, the upper collar (714) may be used to support the weight of the mast (700) and/or the rest of the crane against the support level (708).

In FIG. 7G, the climbing frame (712) is disengaged from the support level (704). Disengagement of the climbing frame (712) may be accomplished using as described above. At this time, the weight of the mast (700) and/or the rest of the crane is supported by the upper collar (714) on the support level (708).

In FIG. 7H, the climbing frame (712) is lowered to the lower collar (716). The climbing frame (712) is then connected to the lower collar (716). If not already connected to the lower collar (716) and/or the climbing frame (712), the mast (700) is connected to one or both of the lower collar (716) and the climbing frame (712).

In FIG. 7I, the lower collar (716) is retracted to disengage with the support level (702). Again, the weight of the mast (700), the rest of the crane, and the lifting components are borne by the upper collar (714) and the support level (708).

In FIG. 7J, the first hydraulic piston (718) and the second hydraulic piston (720) pull on the combination of the climbing frame (712) and the lower collar (716) under a tension load. The climbing frame (712) and the lower collar (716) are pulled just past the support level (704). Because the mast (700) is connected to one or both of the climbing frame (712) and the lower collar (716), the mast (700) is likewise pulled upwardly through the upper collar (714).

In FIG. 7K, the lower collar (716) is extended into an engaged position and allowed to rest on the support level (704). The climbing frame (712) may be disengaged from the lower collar (716). In an embodiment, the lower collar (716) remains connected to the mast (700) such that the weight of the mast (700) and the rest of the crane may now be supportable by the lower collar (716) on the support level (704).

In FIG. 7L, the climbing frame (712), once detached, is lifted in the retracted position past the support level (706). The climbing frame (712) may now be reset for the next climb.

The example of FIG. 7A through FIG. 7L may be varied. For example, it may be possible to skip multiple levels by elevating the upper collar (714) higher initially. Because the first hydraulic piston (718) and the second hydraulic piston (720) are under a tension load, buckling of the piston rods of the first hydraulic piston (718) and second hydraulic piston (720) is unlikely or possible.

In other variations, more collars may be present to further stabilize the mast (700). In still other variations, more than two pistons may be used under a tension load to raise the mast (700). Yet other variations are possible; thus, the one or more embodiments are not necessarily limited by the examples shown in FIG. 7A through FIG. 7L.

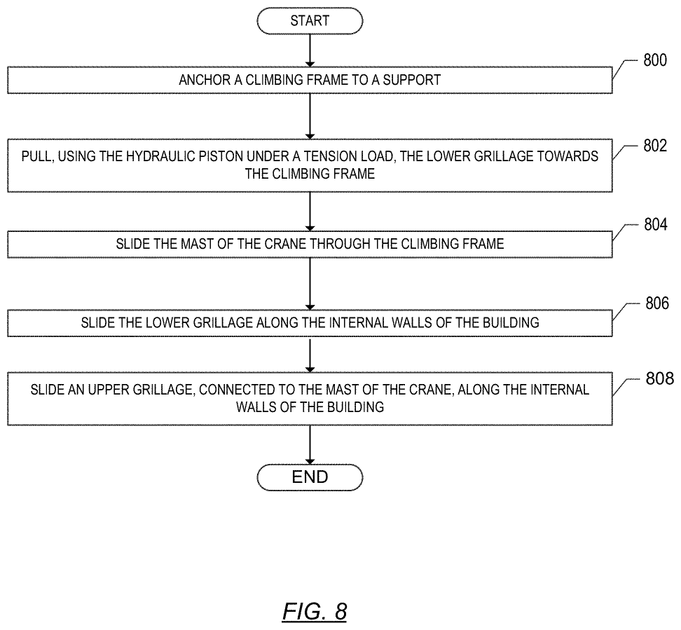

FIG. 8 shows a flowchart of a method for lifting a crane, in accordance with one or more embodiments. The method described with respect to FIG. 8 may be accomplished using the devices and techniques described with respect to FIG. 2A through FIG. 7L. The method of FIG. 8 is exemplary only, as variations and additions may be applied to the method, such as described with respect to the appended claims and the other examples described above.

Step 800 includes anchoring a climbing frame to a support. For example, the climbing frame may be placed into an extended position over a floor of a building, into an inset of a wall of a building, or onto some other support, as described above. The climbing frame is connected to a hydraulic piston that is also connected to a lower grillage disposed under the climbing frame relative to a direction of gravity. The lower grillage is also connected to a mast of a crane.

Step 802 includes pulling, using the hydraulic piston under a tension load, the lower grillage towards the climbing frame. Because the crane is connected to the lower grillage, pulling the lower grillage under a tension load also lifts the crane.

The method shown in FIG. 8 may include other steps. For example, consider the example where the support is the internal walls of a building, such as shown in FIG. 2A through FIG. 2G, or FIG. 3A through FIG. 3C. In this case, the method of FIG. 8 may additional steps, as described below.

Step 804 includes sliding the mast of the crane through the climbing frame. An example of this step is shown in FIG. 3A and FIG. 3B.

Step 806 includes sliding the lower grillage along the internal walls of the building. An example of this step is also shown in FIG. 3A and FIG. 3B.

Step 808 includes sliding an upper grillage, connected to the mast of the crane, along the internal walls of the building. An example of this step is also shown in FIG. 3A and FIG. 3B.

While the various steps in this flowchart are presented and described sequentially, one of ordinary skill will appreciate that some or all of the steps may be executed in different orders, may be combined or omitted, and some or all of the steps may be executed in parallel. Furthermore, in some embodiments the steps may be performed actively and/or passively. Other variations are possible. For example, pulling the lower grillage towards the climbing frame may be accomplished using the first climbing beam (402) or second climbing beam (404) of FIG. 4A, using the climbing frame (606) of FIG. 6A through FIG. 6C, or using the procedure shown in FIG. 7A through FIG. 7L. Thus, the one or more embodiments are not necessarily limited by the example of FIG. 8.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For a non-limiting example, two angles may be “about congruent” if the values of the two angles are within ten percent of each other. However, if an engineer determines that the engineering tolerance for a particular product should be tighter, then “about congruent” could be two angles having values that are within one percent of each other. Likewise, engineering tolerances could be loosened in other embodiments, such that “about congruent” angles have values within twenty percent of each other. In any case, the ordinary artisan is capable of assessing what is an acceptable engineering tolerance for a particular product, and thus is capable of assessing how to determine the variance of measurement contemplated by the term “about.”

As used herein, the term “connected to” contemplates at least two meanings. In a first meaning, unless otherwise stated, “connected to” means that component A was, at least at some point, separate from component B, but then was later joined to component B in either a fixed or a removably attached arrangement. In a second meaning, unless otherwise stated, “connected to” means that component A could have been integrally formed with component B. Thus, for example, assume a bottom of a pan is “connected to” a wall of the pan. The term “connected to” may be interpreted as the bottom and the wall being separate components that are snapped together, welded, or are otherwise fixedly or removably attached to each other. Additionally, the term “connected to” also may be interpreted as the bottom and the wall being contiguously together as a monocoque body formed by, for example, a molding process. In other words, the bottom and the wall, in being “connected to” each other, could be separate components that are brought together and joined, or may be a single piece of material that is bent at an angle so that the bottom panel and the wall panel are identifiable parts of the single piece of material.

While the one or more embodiments have been described with respect to a limited number of embodiments, those skilled in the art, having benefit of this disclosure, will appreciate that other embodiments can be devised which do not depart from the scope of the one or more embodiments as disclosed herein. Accordingly, the scope of the one or more embodiments should be limited only by the attached claims.

What is claimed is:

1. A device comprising:
a climbing frame configured for connection to a support; and
a hydraulic piston connected, at least indirectly, to the climbing frame, the hydraulic piston oriented to urge, under a tension load, a mast of a crane upwardly against a force of gravity.

2. The device of claim 1, further comprising:
a lower grillage, configured for connection to the mast of the crane, disposed below the climbing frame relative to a direction of the gravity; and
a plurality of hydraulic pistons, including the hydraulic piston, connecting the climbing frame to the lower grillage, the plurality of hydraulic pistons oriented to urge the lower grillage towards the climbing frame under the tension load.

3. The device of claim 2, further comprising:
the mast of the crane, the mast connected to the lower grillage; and
an upper grillage disposed above the climbing frame relative to the direction of the gravity, wherein the mast is disposed through the upper grillage.

4. The device of claim 3, wherein:
the support comprises internal walls, beams, columns, or floors of a building to which the climbing frame is anchored, and
the lower grillage and the upper grillage are configured to slide along the internal walls, beams, columns, or floors of the building as the mast is urged through the climbing frame.

5. The device of claim 4, wherein:
the climbing frame comprises a climbing frame, and
the mast is configured to slide through the climbing frame.

6. The device of claim 1, wherein the climbing frame comprises a cross beam.

7. The device of claim 6, wherein:
the cross beam further comprises a flipper assembly connected to an end of the cross beam,
the flipper assembly comprises an engaged state configured to engage the support, and
the flipper assembly comprises a disengaged state configured to slide along the support.

8. The device of claim 6, wherein the device further comprises:
a lower grillage connected to the cross beam by the hydraulic piston, wherein the lower grillage is configured for connection to the mast of the crane.

9. The device of claim 8, wherein the lower grillage is configured to slide along the support.

10. The device of claim 1, wherein the climbing frame comprises a plurality of cross beams, wherein the plurality of cross beams comprises a plurality of flipper assemblies connected to ends of the plurality of cross beams, wherein the plurality of flipper assemblies are configured to removably engage the support, and wherein the device further comprises:
a lower grillage configured for connection to the mast of the crane; and
a plurality of hydraulic pistons, including the hydraulic piston, connecting the lower grillage to the plurality of cross beams.

11. The device of claim 1, wherein the climbing frame comprises a cross beam removably engageable with the support.

12. The device of claim 11, wherein the hydraulic piston is configured for connection to the support.

13. The device of claim 12, wherein the support comprises an internal wall, beams, columns, or floors of a building.

14. The device of claim 12, wherein the hydraulic piston is indirectly connected to the cross beam via a brace.

15. The device of claim 11, wherein the hydraulic piston is configured for connection to the support, wherein the support comprises an internal wall, column, or floor of a building, wherein the hydraulic piston is indirectly connected to the cross beam via a brace, and wherein the device further comprises:
a second cross beam removably engageable to the support, the second cross beam disposed above the cross beam relative to gravity.

16. The device of claim 1, wherein the climbing frame comprises a first pair of retractable ends, and wherein the device further comprises:
an upper grillage comprising a second pair of retractable ends, the upper grillage removably connectable to the mast and disposed above the climbing frame relative to the gravity; and
a lower grillage comprising a third pair of retractable ends, the lower grillage removably connectable to the mast and disposed below the climbing frame relative to the gravity,
wherein the hydraulic piston is removably connectable to the upper grillage and to the climbing frame, and
wherein the climbing frame is removably connectable to the lower grillage.

17. A device, comprising:
a support comprising a first portion of a mast of a crane, wherein the first portion of the mast of the crane is anchored to an anchor point and wherein a second portion of the mast of the crane is unanchored to the first portion;
a climbing frame connected to the second portion of the mast and slidable along the first portion of the mast;
a hydraulic piston connected to the first portion of the mast and to the climbing frame, wherein the hydraulic piston is oriented to pull the climbing frame under a tension load and further oriented to lift the second portion of the mast as the climbing frame is pulled by the hydraulic piston.

18. A system comprising:
a lower grillage configured to slide along internal walls, beams, columns, or floors of a building;
a mast of a crane connected to the lower grillage;
a climbing frame configured for connection to the internal walls, beams, columns, or floors of the building, the climbing frame disposed above the lower grillage relative to a direction of gravity;
a hydraulic piston connecting the lower grillage and the climbing frame, the hydraulic piston oriented to urge the lower grillage towards the climbing frame under a tension load; and
an upper grillage configured to slide along the internal walls, beams, columns, or floors of the building, the upper grillage connected to the mast of the crane above the climbing frame relative to the gravity.

19. A method of lifting a crane, the method comprising:
anchoring a climbing frame to a support,
wherein the climbing frame is connected to a hydraulic piston that is also connected to a lower grillage disposed under the climbing frame relative to a direction of gravity, and
wherein the lower grillage is also connected to a mast of the crane; and
pulling, using the hydraulic piston under a tension load, the lower grillage towards the climbing frame.

20. The method of claim 19, wherein the support comprises internal walls, beams, columns, or floors of a building, and wherein the method further comprises:
sliding the mast of the crane through the climbing frame;
sliding the lower grillage along the internal walls, beams, columns, or floors of the building; and
sliding an upper grillage, connected to the mast of the crane, along the internal walls of the building.
